(19) United States
(12) Patent Application Publication
(10) Pub. No.: US 2010/0169328 A1
(43) Pub. Date: Jul. 1, 2010

(54) SYSTEMS AND METHODS FOR MAKING RECOMMENDATIONS USING MODEL-BASED COLLABORATIVE FILTERING WITH USER COMMUNITIES AND ITEMS COLLECTIONS

(75) Inventor: Rick Hangartner, Corvallis, OR (US)

Correspondence Address: Stolowitz Ford Cowger LLP, 621 SW Morrison St, Suite 600, Portland, OR, 97205, US

(73) Assignee: Strands, Inc., Corvallis, OR (US)

(21) Appl. No.: 12/347,958

(22) Filed: Dec. 31, 2008

(51) Int. Cl. G06F 17/30

(52) U.S. Cl. 707/751; 707/E17.108; 707/E17.109

(57) ABSTRACT

Massively scalable, memory and model-based techniques are an important approach for practical large-scale collaborative filtering. We describe a massively scalable, model-based recommender system and method that extends the collaborative filtering techniques by explicitly incorporating these types of user and item knowledge. In addition, we extend the Expectation-Maximization algorithm for learning the conditional probabilities in the model to coherently accommodate time-varying training data.

### COPYRIGHT NOTICE

©2002-2003 Strands, Inc. The copyright owner has no objection to the facsimile reproduction by anyone of the patent document or the patent disclosure, as it appears in the U.S. Patent and Trademark Office patent file or records, but otherwise reserves all copyright rights whatsoever. 37 CFR §1.71(d).

### TECHNICAL FIELD

This invention pertains to systems and methods for making recommendations using model-based collaborative filtering with user communities and items collections.

### BACKGROUND

It has become a cliché that attention, not content, is the scarce resource in any internet market model. Search engines are imperfect means for dealing with attention scarcity since they require that a user has reasoned enough about the items to which he or she would like to devote attention to have attached some type of descriptive keywords. Recommender engines seek to replace the need for user reasoning by inferring a user's interests and preferences implicitly or explicitly and recommending appropriate content items for display to and attention by the user.

Exactly how a recommender engine infers a user's interests and preferences remains an active research topic linked to the broader problem of understanding in machine learning. In the last two years, as large-scale web applications have incorporated recommendation technology, these areas in machine learning evolve to include problems in data-center scale, massively concurrent computation. At the same time, the sophistication of recommender architectures increased to include model-based representations for knowledge used by the recommender, and in particular models that shape recommendations based on the social networks and other relationships between users as well as a prior specified or learned relationships between items, including complementary or substitute relationships.

In accordance with these recent trends, we describe systems and methods for making recommendations using model-based collaborative filtering with user communities and item collections that is suited to data-center scale, massively concurrent computations.

### BRIEF DRAWINGS DESCRIPTION

FIG. 1(a) is a user-item-factor graph.

FIG. 1(b) is a item-item-factor graph.

FIG. 2 is an embodiment of a data model including user communities and items collections for use in a system and method for making recommendations.

FIG. 3 is an embodiment of a data model including user communities and items collections for use in a system and method for making recommendations.

FIG. 4 is an embodiment of a system and method for making recommendations.

### DETAILED DESCRIPTION

Additional aspects and advantages of this invention will be apparent from the following detailed description of preferred embodiments, which proceeds with reference to the accompanying drawings.

We begin by a brief review of memory-based systems and a more detailed description of model-based systems and methods. We end with a description of adaptive model-based systems and methods that compute time-varying conditional probabilities.

A Formal Description of the Recommendation Problem

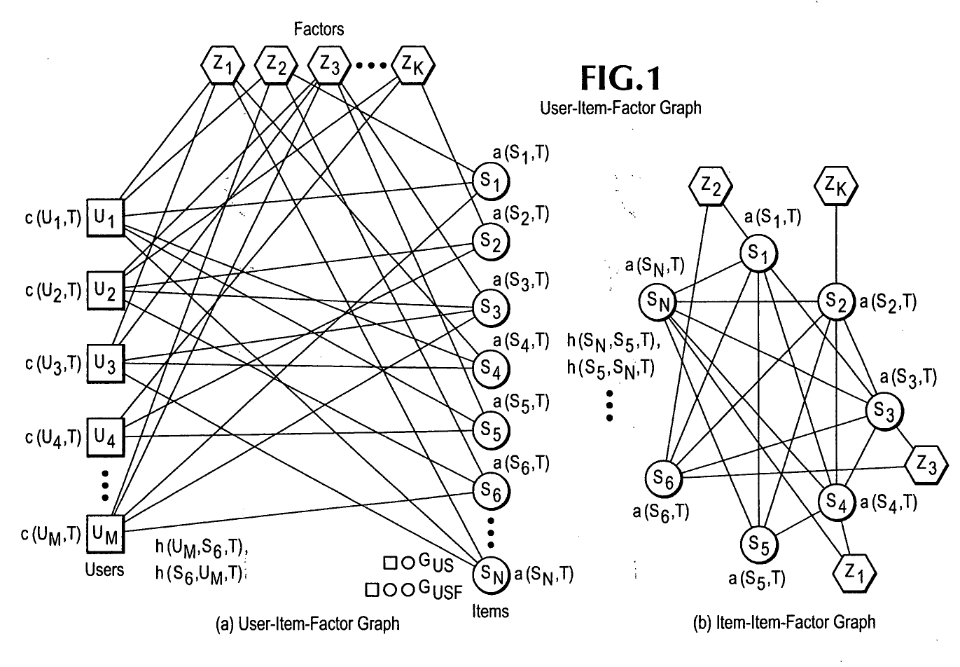

Tripartite graph [symbol] _{USF} shown in FIG. 1(a) models matching users to items. The square nodes [symbol] ={u₁, u₂, . . . , u_{M}} represent users and the round nodes [symbol] ={s₁, s₂, . . . , s_{N}} represent items. In this context, a user may be a physical person. A user may also be a computing entity that will use the recommended content items for further processing. Two or more users may form a cluster or group having a common property, characteristic, or attribute. Similarly, an item may be any good or service. Two or more items may form a cluster or group having a common property, characteristic, or attribute. The common property, characteristic, or attribute of an item group may be connected to a user or a cluster of users. For example, a recommender engine may recommend books to a user based on books purchased by other users having similar book purchasing histories.

The function c(u; τ) represents a vector of measured user interests over the categories [symbol] for user u at time instant τ. Similarly, the function a(s; τ) represents a vector of item attributes [symbol] for item s at time instant τ. The edge weights h(u, s; τ) are measured data that in some way indicate the interest user u has in item s at time instant τ. Frequently h(u, s; n) is visitation data but may be other data, such as purchasing history. For expressive simplicity, we will ordinarily omit the time index τ unless it is required to clarify the discussion.

The octagonal nodes [symbol] ={z₁, z₂, . . . , z_{K}} in the [symbol] _{USF} graph are factors in an underlying model for the relationship between user interests and items. Intuition suggests that the value of recommendations traces to the existence of a model that represents a useful clustering or grouping of users and items. Clustering provides a principled means for addressing the collaborative filtering problem of identifying items of interest to other users whose interests are related to the user's, and for identifying items related to items known to be of interest to a user.

Modeling the relationship between user interests and items may involve one or two types of collaborative filtering algorithms. Memory-based algorithms consider the graph [symbol] _{US} without the octagonal factor nodes in [symbol] _{USF} of FIG. 1(a) essentially to fit nearest-neighbor regressions to the high-dimension data. In contrast, model-based algorithms propose that solutions for the recommender problem actually exist on a lower-dimensional manifold represented by the octagonal nodes.

Memory-Based Algorithms

As defined above, a memory-based algorithm fits the raw data used to train the algorithm with some form of nearest-neighbor regression that relates items and users in a way that has utility for making recommendations. One significant class of these systems can be represented by the non-linear form

X=f(h(u₁,s₁), . . . ,h(u_{M},s_{N}),c(u₁), . . . ,c(u_{M}),a(s₁), . . . ,a(s_{N}),X) (1)

where X is an appropriate set of relational measures. This form can be interpreted as an embedding of the recommender problem as fixed-point problem in an |U|+|S | dimension data space.

Implicit Classification Via Linear Embeddings

The embedding approach seeks to represent the strength of the affinities between users and items by distances in a metric space. High affinities correspond to smaller distances so that users and items are implicitly classified into groupings of users close to items and groupings of items close to users. A linear convex embedding may be generalized as

$$\begin{matrix}X = [ \begin{matrix}0 & {H}_{US} \\ {H}_{SU} & 0\end{matrix} ] [ \begin{matrix}{X}_{UU} & {X}_{US} \\ {X}_{SU} & {X}_{SS}\end{matrix} ] {\sum }_{n = 1}^{M + N} {X}_{mn} = 1 \\ = HX\end{matrix} \qquad ( 2 )$$

where H is matrix representation for the weights, with submatrices H_{US} and H_{SU} such that h_{US;mn}=h(uₘ, sₙ) and h_{SU;mn}=h(sₙ, uₘ). The desired affinity measures describing the affinity of user uₘ for items s₁, . . . , s_{N} is the m-th row of the submatrix X_{US}. Similarly, the desired measures describing the affinity of users u₁, . . . , u_{M} for item sₙ is the n-th row of the submatrix X_{SU}. The submatrices X_{UU}=H_{US}X_{SU} and X_{SS}=H_{SU}X_{US} are user-user and item-item affinities, respectively.

If a non-zero X exists that satisfies (2) for a given H, it provides a basis for building the item-item companion graph [symbol] _{UU} shown in FIG. 1(b). There are a number of ways that the edge weights h′(s₁, s_{N}) representing the similarities of the item nodes sₗ and sₙ in the graph can be computed. One straightforward solution is to consider h(uₘ, sₙ) and h(sₙ, uₘ) to be proportional to the strength of the relationship between item uₘ and sₙ, and the relationship between sₙ and uₘ, respectively. Then we can let the strength of the relationship between sₗ and sₘ, as

$${h}^{′} ( {s}_{l} , {s}_{n} ) = {\sum }_{m = 1}^{M} h ( {s}_{l} , {u}_{m} ) h ( {u}_{m} , {s}_{n} )$$

so the entire set of relationships can be represented in matrix form as V=H_{SU}H_{US}. The affinity of sₗ and sₙ then satisfies

X_{SS}=H′X_{SS}=H_{SU}H_{US}X_{SS}

which can be derived directly from (2) since

$$X = [ \begin{matrix}{H}_{US} {H}_{SU} & 0 \\ 0 & {H}_{SU} {H}_{US}\end{matrix} ] X = {H}^{2} X$$

In memory-based recommenders, the proposed embedding does not exist for an arbitrary weighted bipartite graph [symbol] _{US}. In fact, an embedding in which X has rank greater than 1 exists for a weighted bipartite g_{US} if and only if the adjacency matrix has a defective eigenvalue. This is because H has the decomposition

$$H = Y [ \begin{matrix}{λ}_{1} I + {T}_{1} & ⋯ & 0 \\ ⋮ & ⋰ & ⋮ \\ 0 & ⋯ & {λ}_{k} I + {T}_{k}\end{matrix} ] {Y}^{- 1}$$

where the Y is a non-singular matrix, λ₁, . . . , λₖ and T₁, . . . , Tₖ are upper-triangular submatrices with 0's on the diagonal. In addition, the rank of the null-space of Tᵢ is equal to the number of independent eigenvectors of H associated with eigenvalue λᵢ. Now, if λ₁=1 is a non-defective eigenvalue with algebraic multiplicity greater than 1, Tᵢ=0.

Q is a real, orthogonal matrix and Λ is a diagonal matrix with the eigenvalues of H on the diagonal. The form (2) implies that W has the single eigenvalue “1” so that Λ=I and

H=QIQ^{T}=I

Now, an arbitrary defective H can be expressed as

H=Y[I+T]Y⁻¹=I+YTY⁻¹

where Y is non-singular and T is block upper-triangular with “0”'s on the diagonal. The rank of the null-space is equal to the number of independent eigenvectors of H. If H is non-defective, which includes the symmetric case, T must be the 0 matrix and we see again that H=1.

Now on the other hand, if H is defective, from (2) we have (H−I)X=0 and we see that

YTY⁻¹X=0

where the rank of the null-space of T is less than N+M. For an X to exist that satisfies the embedding (2), there must exist a graph [symbol] _{US} with the singular adjacency matrix H−I. This is simply the original graph [symbol] _{US} with a self-edge having weight −1 added to each node. The graph [symbol] _{US} is no longer bipartite, but it still has a bipartite quality: If there is no edge between two distinct nodes in [symbol] _{US}, there is no edge between two nodes in [symbol] _{US}. Various structural properties in [symbol] _{US} can result in a singular adjacency matrix H=I. For the matrix X to be non-zero and the proposed embedding to exist, H must have properties that correspond to strong assumptions on users' preferences.

The Adsorption Algorithm

The linear embedding (2) of the recommendation problem establishes a structural isomorphism between solutions to the embedding problem and the solutions generated by adsorption algorithm for some recommenders. In a generalized approach, the recommender associates vectors p_{c} (uₘ) and p_{A} (sₙ) representing probability distributions Pr(c; uₘ) and Pr(a; sₙ) over [symbol] and [symbol] respectively, with the vectors c(uₘ) and a(sₙ) such that

$$\begin{matrix}P = [ \begin{matrix}0 & {H}_{US} \\ {H}_{SU} & 0\end{matrix} ] [ \begin{matrix}{P}_{UA} & {P}_{UC} \\ {P}_{SA} & {P}_{SC}\end{matrix} ] {\sum }_{n = 1}^{\vert 𝒞 \vert + \vert \vert} {P}_{mn} = 1 \\ = HP\end{matrix} \\ where \\ {P}_{UA} = [ \begin{matrix}{p}_{A}^{T} ( {u}_{1} ) \\ ⋮ \\ {p}_{A}^{T} ( {u}_{M} )\end{matrix} ] {P}_{UC} = [ \begin{matrix}{p}_{C}^{T} ( {u}_{1} ) \\ ⋮ \\ {p}_{C}^{T} ( {u}_{M} )\end{matrix} ] \\ {P}_{SA} = [ \begin{matrix}{p}_{Λ}^{T} ( {s}_{1} ) \\ ⋮ \\ {p}_{Λ}^{T} ( {s}_{N} )\end{matrix} ] {P}_{SC} = [ \begin{matrix}{p}_{C}^{T} ( {s}_{1} ) \\ ⋮ \\ {p}_{C}^{T} ( {s}_{N} )\end{matrix} ] \qquad ( 3 )$$

The matrices P_{SA} and P_{UC} are matrices composed of the [symbol] distrubution p_{A} (sₙ) and the [symbol] distributions p_{c} (uₘ) written as row vectors. The [symbol] distributions p_{A} (uₘ) a [symbol] distributions p_{c} (sₙ) that form the row vectors of the matrices P^{UA} and P_{SC} matrices are the projections of the distributions in P_{SA} and P_{UC}, respectively, under the linear embedding (2).

Although P is an ( [symbol] + [symbol] )×( [symbol] + [symbol] ) matrix, it bears a specific relationship to the matrix X that implies that if the 0 matrix is the only solution for X then the 0 matrix if the only solution for P. The columns of P must have the columns of X as a basis and therefore the column space has dimension M+N at most. If X does not exist, then the null space of YTY⁻¹ has dimension M+N and P must be the 0 matrix if W is not the identity matrix.

Conversely, if X exists, even though a non-zero P that meets the row-scaling constraints on P in (3) may not exist, a non-zero

P_{R}=r⁻¹[X|X| . . . |X]

composed of

r=┌( [symbol] + [symbol] )/( [symbol] + [symbol] )┐

replications of X that meets the row-scaling constraints does exist. From this we deduce an entire subspace of matrices P_{R} exists. A P with [symbol] + [symbol] columns selected from any matrix in this subspace and rows re-nonnalized to meet the row-scaling constraints may be a sufficient approximation for many applications.

Embedding algorithms including the adsorption algorithm are learning methods for a class of recommender algorithms. The key idea behind the adsorption algorithm that similar item nodes will have similar component metric vectors p_{A} (sₙ) does provide the basis for an adsorption-based recommendation algorithm. The component metrics p_{A} (sₙ) can be approximated by several rounds of an iterative MapReduce computation with run-time [symbol] (M+N). The component metrics may be compared to develop lists of similar items. If these comparisons are limited to a fixed-sized neighborhood, they can be easily parallelized as a MapReduce computation with run-time (N). The resulting lists are then used by the recommender to generate recommendations.

Model-Based Algorithms

Memory-based solutions to the recommender problem may be adequate for many applications. As shown here though, they can be awkward and have weak mathematical foundations. The memory-based recommender adsorption algorithm proceeds from the simple concept that the items a user might find interesting should display some consistent set of properties, characteristics, or attributes and the users to whom an item might appeal should have some consistent set of properties, characteristics, or attributes. Equation (3) compactly expresses this concept. Model-based solutions can offer more principled and mathematically sound grounds for solutions to the recommender problem. The model-based solutions of interest here represent the recommender problem with the full graph [symbol] _{USF} that includes the octagonal factor nodes shown in FIG. 1(a).

Explicit Classification In Collaborative Filters

To further clarify the conceptual difference between the particular family of memory-based algorithms that we describe above, and the particular family of model-based algorithms that we describe below, we focus on how each algorithm classifies users and items. The family of adsorption algorithms we discuss above explicitly computes vector of probabilities p_{c} (u) and p_{A} (s) that describe how much interests in set [symbol] apply to user u and attributes in set A apply to item s, respectively. These probability vectors implicitly define communities of users and items which a specific implementation may make explicit by computing similarities between users and between items in a post-processing step.

Recommenders incorporating model-based algorithms explicitly classify users and items into latent clusters or groupings, represented by the octagonal factor nodes [symbol] ={z₁, . . . , z_{K}} in FIG. 1(b), which match user communities with item collections of interest to the factor zₖ. The degree to which user uₘ and item sₙ belong to factor zₖ is explicitly computed, but generally, no other descriptions of the properties of users and items corresponding to the probability vectors in the adsorption algorithms and which can be used to compute similarities are explicitly computed. The relative importance of the interests in [symbol] of similar users and the relative importance of the attributes in [symbol] of similar items can be implicitly inferred from the characteristic descriptions for users and items in the factors zₖ.

Probabilistic Latent Semantic Indexing Algorithms

A recommender may implement a user-item co-occurrence algorithm from a family of probabilistic latent semantic indexing (PLSI) recommendation algorithms. This family also includes versions that incorporate ratings. In simplest terms, given T user-item data pairs [symbol] ={(uₘ_{₁}, Sₙ_{₁}), . . . , (uₘ_{_{T}}, sₙ_{_{T}})}, the recommender estimates a conditional probability distribution Pr(s|u, θ) that maximizes a parametric maximum likelihood estimator (PMLE)

$$\hat{R} ( θ ) = {\prod }_{( u , s ) ∈ 𝒟} Pr ( s \vert u , θ ) = {\prod }_{u ∈ 𝒰} {\prod }_{s ∈ 𝒮} {Pr ( s \vert u , θ )}^{{b}_{us}}$$

where bᵤₛ is the number of occurrences of the user-item pair (u, s) in the input data set. Maximizing the PMLE is equivalent to minimizing the empirical logarithmic loss function

$$R ( θ ) = - \frac{1}{T} log \hat{R} ( θ ) = - \frac{1}{T} {\sum }_{u ∈ 𝒰} {\sum }_{s ∈ 𝒮} {b}_{us} log Pr ( s \vert u , θ ) \qquad ( 4 )$$

The PLSI algorithm treats users uₘ and items sₙ as distinct states of a user variable u and an item variable s, respectively. A factor variable z with the factors sₖ as states is associated with each user and item pair so that the input actually consists of triples (uₘ, sₙ, zₖ), where zₖ is a hidden data value such that the user variable u conditioned on z and the item variable s conditioned on z are independent and

$$\begin{matrix}Pr ( z \vert u , s ) Pr ( s \vert u ) Pr ( u ) = Pr ( u , s \vert z ) Pr ( z ) \\ = Pr ( s \vert z ) Pr ( u \vert z ) Pr ( z ) \\ = Pr ( s \vert z ) Pr ( z \vert u ) Pr ( u ) \\ = Pr ( s , z \vert u ) Pr ( u )\end{matrix}$$

The conditional probability Pr(s|u, θ) which describes how much item s ∈ [symbol] is likely to be of interest to user u ∈ [symbol] then satisfies the relationship

$$Pr ( s \vert u , θ ) = {\sum }_{z ∈ 𝒵 -} Pr ( s \vert z ) Pr ( z \vert u ) \qquad ( 5 )$$

The parameter vector θ is just the conditional probabilities Pr(z|u) that describe how much user u interests correspond to factor z ∈ [symbol] and the conditional probabilities Pr(s|z) that describe how likely item s is of interest to users associated with factor z. The full data model is Pr(s, z|u)=Pr(s|z) Pr(z|u) with a loss function

$${R}^{′} ( θ ) = - \frac{1}{T} {\sum }_{( u , s , z ) ∈ 𝒟 }^{ } log Pr ( s , z \vert u ) \\ = - \frac{1}{T} {\sum }_{( u , s , z ) ∈ 𝒟} [ log Pr ( s \vert z ) + log Pr ( z \vert u ) ] \qquad ( 6 )$$

where the input data [symbol] actually consists of triples (u, s, z) in which z is hidden. Using Jensen's Inequality and (5) we can derive an upper-bound on R(θ) as

$$R ( θ ) = - \frac{1}{T} {\sum }_{( u , s ) ∈ 𝒟 }^{ } log {\sum }_{z ∈ 𝒵 -} Pr ( s \vert z ) Pr ( z \vert u ) \leq - \frac{1}{T} {\sum }_{( u , s ) ∈ 𝒟} {\sum }_{z ∈ 𝒵 -} [ log Pr ( s \vert z ) + log {Pr ( z \vert u )}_{.}^{.} \qquad ( 7 )$$

Combining (6) and (7) we see that

$${R}^{′} ( θ ) \leq R ( θ ) \leq - \frac{1}{T} {\sum }_{( u , s ) ∈ 𝒟}^{ } {\sum }_{z ∈ 𝒵 -} [ log Pr ( s \vert z ) + log Pr ( z \vert u ) ]$$

Unlike the Latent Semantic Indexing (LSI) algorithm that estimates a single optimal zₖ estimated for every pair (uₘ, sₙ), the PLSI algorithm [5], [6] estimates the probability of each state zₖ for each (uₘ, sₙ) by computing the conditional probabilities in (5) with, for example, an Expectation Maximization (EM) algorithm as we describe below. The upper bound (7) on R(θ) can be re-expressed as

$$\begin{matrix}F ( Q ) = - \frac{1}{T} {\sum }_{( u , s ) ∈ 𝒟 }^{ } {\sum }_{z ∈ 𝒵 -} Q ( z \vert u , s , θ ) \{ log Pr ( s \vert z ) + log Pr ( z \vert u ) ] - \\ log Q ( z \vert u , s , θ ) \} \\ = R ( θ , Q ) + \frac{1}{T} {\sum }_{( u , s ) ∈ 𝒟 }^{ } {\sum }_{z ∈ 𝒵 -} Q ( z \vert u , s , θ ) log Q ( z \vert u , s , θ )\end{matrix} \qquad ( 8 )$$

where Q(z|u, s, θ) is a probability distribution. The PLSI algorithm may minimize this upper bound by expressing the optimal Q*(z|u, s, θ) in terms of the components Pr(s|z) and Pr(z|u) of θ, and then finding the optimal values for these conditional probabilities.

E-step: The “Expectation” step computes the optimal Q*(z|u, s, θ⁻)⁺=Pr(z|u, s, θ) that minimizes F(Q), taking as the values of θ⁻ for this iteration the values of θ⁺from the M-step of the previous iteration

$${{Q}^{*} ( z \vert u , s , {θ}^{-} )}^{+} = \frac{{Pr ( s \vert z )}^{-} {Pr ( zu )}^{-}}{{Pr ( s \vert u )}^{-}} = \frac{{Pr ( s \vert z )}^{-} {Pr ( z \vert u )}^{-}}{{\sum }_{z ∈ 𝒵 -} {Pr ( s \vert z )}^{-} {Pr ( z \vert u )}^{-}} \qquad ( 9 )$$

M-step: The “Maximization” step then computes new values for the conditional probabilities θ⁺={Pr(s|z)⁻, Pr(z|u)⁻} that minimize R(θ, Q) directly from the Q*(z|u, s, θ⁻)⁺ values from the E-step as

$$\begin{matrix}{Pr ( s \vert z )}^{+} = \frac{{\sum }_{( u , s ) ∈ 𝒟 (* , s )} {{Q}^{*} ( z \vert u , s , {θ}^{-} )}^{+}}{{\sum }_{( u , s ) ∈ 𝒟} {{Q}^{*} ( z \vert u , s , {θ}^{-} )}^{+}} & ( 10 ) \\ {Pr ( z \vert u )}^{+} = \frac{{\sum }_{( u , s ) ∈ 𝒟 ( u , *)} {{Q}^{*} ( z \vert u , s , {θ}^{-} )}^{+}}{{\sum }_{z ∈ 𝒵 -} {\sum }_{( u , s ) ∈ 𝒟 ( u , *)} {{Q}^{*} ( z \vert u , s , {θ}^{-} )}^{+}} & ( 11 )\end{matrix}$$

where [symbol] u, ·) and [symbol] (·, s) denote the subsets of [symbol] for user u and item s, respectively.

Since Q*(z|u, s, θ) results in the optimal upper bound on the minimum value of R(θ), and the second component of the expression (8 for F(Q) does not depend on θ, these values for the conditional probabilities θ={Pr(s|z), Pr(z|u)} are the optimal estimates we seek.¹ The new values for the conditional probabilities θ⁺={Pr(s|z)⁺, Pr(z|u)⁺} that maximize Q*(z, u, s, θ), and therefore minimize R(θ, Q), are then computed. ¹ It happens that the adsorption algorithm of memory-based recommender we describe above can be viewed as a degenerate EM algorithm. The loss function to be minimized is R(X)=X−MX. There is no E-step because there are no hidden variables, and the M-step is just the computation of the matrix X of point probabilities that satisfy (2).

One insight that might further understanding how the EM algorithm minimizes the loss function R(θ, Q) with regard to a particular data set is that the EM iteration is only done for the pairs (uₘ_{ᵢ}, sₙ_{ᵢ}) that occur in the data with the users u ∈ [symbol] items s ∈ [symbol] and the number of factors z ∈ [symbol] fixed in at the start of the computation. Multiple occurrences of (uₘ, sₙ), typically reflected in the edge weight function h(uₘ, sₙ) are indirectly factored into the minimization by multiple iterations of the EM algorithm.² To match the expected slow rate of increase in the number of users, but relatively faster expected rate of increase in items, an implementation of the EM iteration as a Map-Reduce computation actually is an approximation that fixes the users [symbol] and then number of factors in [symbol] in advance, but which allows the number of items in [symbol] to increase. ² Modifications to the model are presented in [6] that deal with potential over-fitting problems due to sparseness of the data set.

As new items are added, the approximate algorithm does not re-compute the probabilities Pr(s|z) by the EM algorithm. Instead, the algorithm keeps a count for each item Sₙ in each factor zₖ and incriminates the count for sₙ in each factor zₖ for which Pr(zₖ|uₘ) is large, indicating user uₘ has a strong probability of membership, for each item sₙ user uₘ accesses. The counts for the sₙ, in each factor zₖ are normalized to serve as the value Pr(sₙ|zₖ), rather than the formal value in between re-computations of the model by the EM algorithm.

Like the adsorption algorithm, the EM algorithm is a learning algorithm for a class of recommender algorithms. Many recommenders are continuously trained from the sequence of user-item pairs (uₘ_{ᵢ}, sₙ_{ᵢ}). The values of Pr(s|z) and Pr(z|u) are used to compute factors zₖ linking user communities and item collections that can be used in a simple recommender algorithm. The specific factors zₖ associated with the user communities for which user u has the most affinity are identified from the Pr(z|u) and then recommended items s are selected from those item collections most associated with those communities based on the values Pr(s|z).

A Classification Algorithm With Prescribed Constraints

In an embodiment, an alternate data model for user-item pairs and a nonparametric empirical likelihood estimator (NPMLE) for the model can serve as the basis for a model-based recommender. Rather than estimate the solution for a simple model for the data, the proposed estimator actually admits additional assumptions about the model that in effect specify the family of admissible models and that also that incorporates ratings more naturally. The NPMLE can be viewed as nonparametric classification algorithm which can serve as the basis for a recommender system. We first describe the data model and then detail the nonparametric empirical likelihood estimator.

A User Community and Item Collection Constrained Data Model

FIG. 1(a) conceptually represents a generalized data model. In this embodiment, however, we assume the input data set consists of three bags of lists:
1. a bag [symbol] of lists [symbol] ={(u_{i*}, sᵢ_{₁}, hᵢ_{₁}), . . . , (u_{i*}, sᵢ_{ₙ}, hᵢ_{ₙ})} of triples, where hᵢ_{ₙ} is a rating that user u_{i*} implicitly or explicitly assigns item sᵢ_{ₙ},
2. a bag ε of user communities ε₁={uₗ_{₁}, . . . , uₗ_{ₘ}}, and
3. a bag [symbol] of item collections [symbol] ₖ={sₖ_{₁}, . . . , sₖ_{ₙ}}.

By accepting input data in the form of lists, we seek to endow the model with knowledge about the complementary and substitute nature of items gained from users and item collections, and with knowledge about user relationships. For data sources that only produce triples (u, s, h), we assume the set [symbol] of lists that capture this information about complementary or substitute items can be built by selecting lists of triples from an accumulated pool based on relevant shared attributes. The most important of these attributes would be the context in which the items were selected or experienced by the user, such as a defined (short) temporal interval.

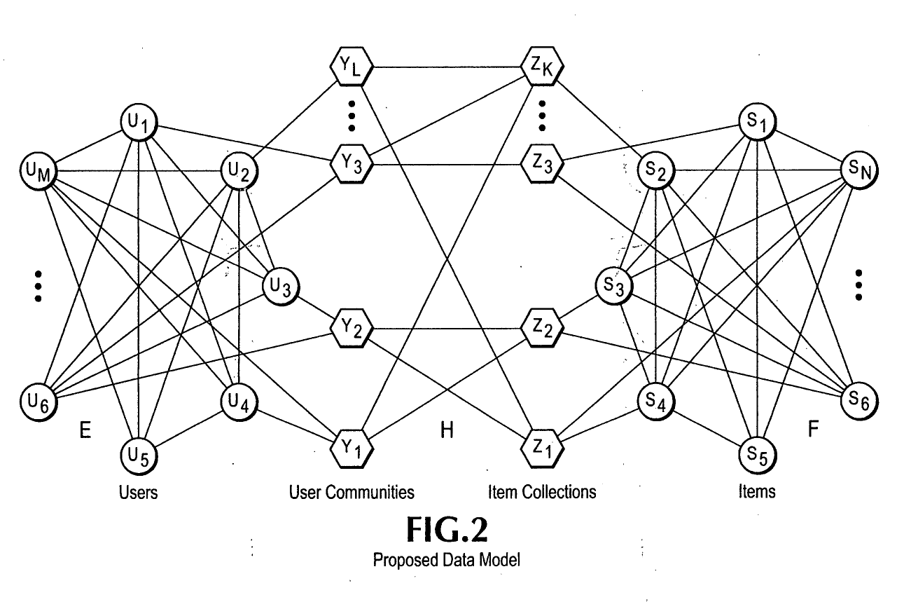

A useful data model should include an alternate approach to identifying factors that reflects the complementary or substitute nature of items inferred from user lists [symbol] and item collections ε, as well as the perceived value of recommendations based on a user's social or other relationships inferred from the user communities [symbol] as approximately represented by the graph G_{HEF} depicted in FIG. 2.

As for the PLSI model with ratings, our goal is to estimate the distribution Pr(h, s|S, u) given the observed data [symbol] ε, and [symbol] Because user ratings may not be available for a given user in a particular application, we re-express this distribution as

Pr(h,s|S,u)=Pr(h|s,S,u)Pr(s|S,u) (12)

where S={sₙ_{₁}, . . . , sₙ_{ⱼ}} is a set of seed items, and we design our data model to support estimation of Pr(s|S, u) and Pr(h|s, S, u) as separate sub-problems. The observed data has the generative conditional probability distribution

$$Pr ( ℋ \vert ɛ , ℱ ) = \frac{Pr ( ℋ , ɛ , ℱ )}{Pr ( ɛ , ℱ )} \qquad ( 13 )$$

To formally relate these two distributions, we first define the set [symbol] (U, S, H) ⊂ [symbol] of lists [symbol] that include any triple (u, s, h) ∈U×S×H and let S ⊂ [symbol] be a set of seed items. Then

$$Pr ( s , S , u ) = \frac{Pr ( s , S \vert u )}{Pr ( S \vert u )} \\ = \frac{Pr ( s , S , u )}{Pr ( S , u )} \\ = \frac{{\sum }_{{ℋ}_{l} ∈ ℋ ( \{ u \} , \{ s \} ⋃ S , H )} Pr ( {ℋ}_{l} \vert ℰ , ℱ )}{{\sum }_{{ℋ}_{l} ∈ ℋ ( \{ u \} , S , H )} Pr ( {ℋ}_{l} \vert ℰ , ℱ )}$$

$$Pr ( h \vert s , S , u ) = \frac{Pr ( h , s \vert S , u )}{Pr ( s \vert S , u )} \\ = \frac{Pr ( h , s , S , u )}{Pr ( s , S , u )} \\ = \frac{{\sum }_{{ℋ}_{l} ∈ ℋ ( \{ u \} , \{ s \} ⋃ S , h )} Pr ( {ℋ}_{l} \vert ℰ , ℱ )}{{\sum }_{{ℋ}_{l} ∈ ℋ ( \{ u \} , \{ s \} ⋃ S , H )} Pr ( {ℋ}_{l} \vert ℰ , ℱ )}$$

The primary task then is to derive a data model for [symbol] and estimate the parameters of that model to maximize the probability

$$R = {\prod }_{{ℋ}_{1} ∈ ℋ} {\prod }_{{ℰ}_{i} ∈ ℰ} {\prod }_{{ℱ}_{j} ∈ ℱ} Pr ( {ℋ}_{l} , {ℰ}_{i} , {ℱ}_{j} ) \\ = {\prod }_{{ℋ}_{1} ∈ ℋ} {\prod }_{{ℰ}_{i} ∈ ℰ} {\prod }_{{ℱ}_{j} ∈ ℱ} Pr ( {ℋ}_{l} \vert {ℰ}_{i} , {ℱ}_{j} ) Pr ( {ℰ}_{i} ) Pr ( {ℱ}_{j} ) \qquad ( 14 )$$

given the observed data [symbol] ε, and

[symbol]

Estimating the Recommendation Conditionals

As a practical approach to maximizing the probability R, we first focus on estimating Pr(s|S, u) by maximizing Pr(s, S, u) for the data sets [symbol] ε, and [symbol] We do this by introducing latent variables y and z such that

$$Pr ( s , S , u ) = {\sum }_{z ∈ 𝒵 -} {\sum }_{y ∈ 𝒴} Pr ( s , S , u , z , y )$$

so we can express the joint probability Pr(s, S, u) in terms of independent conditional probabilities. We assume that s, S, and y are conditionally independent with respect to z, and that u and z are conditionally independent with respect to y

Pr(s,S,y|z)=Pr(s|z)Pr(y|z)=Pr(s,S|y,z)Pr(y|z) Pr(u,z|y)=Pr(u|y)=Pr(u|z,y)Pr(z|y)

We can then rewrite the joint probability

$$\begin{matrix}Pr ( s , S , u , y , z ) = Pr ( s , S , z , y \vert u ) Pr ( u ) \\ = Pr ( z , y \vert s , S , u ) Pr ( s , S \vert u ) Pr ( u )\end{matrix} \\ as \\ \begin{matrix}Pr ( z , y \vert s , S , u ) Pr ( s , S \vert u ) Pr ( u ) = Pr ( u , s , S \vert z , y ) Pr ( z , y ) \\ = Pr ( s , S \vert z , y ) Pr ( u \vert z , y ) \\ Pr ( z , y ) - Pr ( s , S \vert z , y ) \\ Pr ( z \vert y , u ) Pr ( y \vert u ) Pr ( u ) \\ = Pr ( s , S \vert z ) Pr ( z \vert y ) \\ Pr ( y \vert u ) Pr ( u ) \\ = Pr ( s \vert z ) {\prod }_{{s}^{′} ∈ S} Pr ( {s}^{′} \vert z ) \\ Pr ( z \vert y ) Pr ( y \vert u ) Pr ( u )\end{matrix} \qquad ( 15 )$$

Finally, we can derive an expression for Pr(s|S, u) by first summing (15) over z and y to compute the marginal Pr(s, S, u) and factoring out Pr(u)

$$Pr ( s , S \vert u ) = {\sum }_{z ∈ 𝒵 -} {\sum }_{y ∈ 𝒴} Pr ( s \vert z ) {\prod }_{{s}^{′} ∈ S} Pr ( {s}^{′} \vert z ) Pr ( z \vert y ) Pr ( y \vert u ) \qquad ( 16 )$$

and then expanding the conditional as

$$Pr ( s \vert S , u ) = \frac{{\sum }_{z ∈ 𝒵 -} {\sum }_{y ∈ 𝒴} Pr ( s \vert z ) {\prod }_{{s}^{′} ∈ S} Pr ( {s}^{′} \vert z ) Pr ( z \vert y ) Pr ( y \vert u )}{{\sum }_{z ∈ 𝒵 -} {\sum }_{y ∈ 𝒴} {\prod }_{{s}^{′} ∈ S} Pr ( {s}^{′} \vert z ) Pr ( z \vert y ) Pr ( y \vert u )} \qquad ( 17 )$$

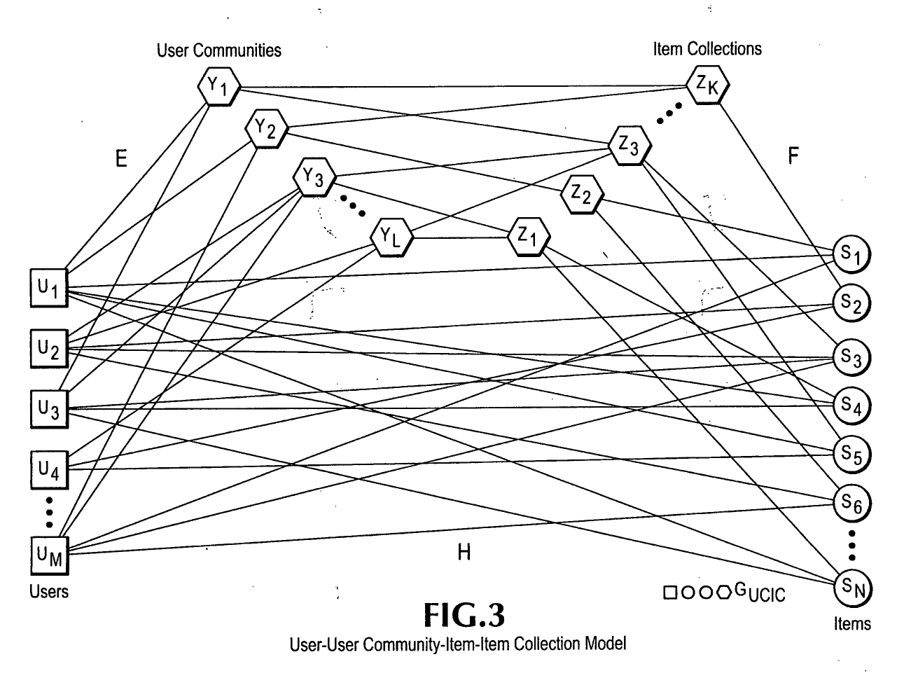

Equation (16) expresses the distribution Pr(s, S|u) as a product of three independent distributions. The conditional distribution Pr(s|z) expresses the probability that item s is a member of the latent item collection z. The conditional distribution Pr(y|u) similarly expresses the probability that the latent user community y is representative for user u. Finally, the probability that items in collection z are of interest to users in community y is specified by the distribution Pr(z|y). We compose these relationships between users and items into the full data model by the graph G_{UCIC} shown in FIG. 3. We describe next how the distribution can be estimated from the input item collections [symbol] the user communities ε, and user lists [symbol] respectively, using variants of the expectation maximization algorithm.

User Community and Item Collection Conditionals

The estimation problem for the user community conditional distribution Pr(y|u) and for the item collection conditional distribution Pr(s|z) is essentially the same. They are both computed from lists that imply some relationship between the users or items on the lists that is germane to making recommendations. Given the set ε of lists of users and the set [symbol] of lists of items, we can compute the conditionals Pr(y|u) and Pr(s|z) several ways.

One very simple approach is to match each user community εₗ with a latent factor yₗ and each item collection [symbol] ₖ with a latent factor zₖ. The conditionals could be the uniform distributions

$$Pr ( {y}_{l} \vert u ) = \frac{1}{\vert \{ {ℰ}_{l} \vert u ∈ {ℰ}_{l} \} \vert} Pr ( s \vert {z}_{k} ) = \frac{1}{\vert {ℱ}_{k} \vert}$$

While this approach is easily implemented, it potentially results in a large number of user community factors y ∈ γ and item collection factors z ∈ [symbol] . Estimating Pr(z|y) is a correspondingly large computation task. Also, recommendations cannot be made for users in a community εₗ if [symbol] does not include a list for at least one user in εₗ. Similarly, items in a collection Fₖ cannot be recommended if no item on [symbol] ₖ occurs on a list in

[symbol]

Another approach is simply to use the previously described EM algorithm to derive the conditional probabilities. For each list εᵢ in ε we can construct M² pairs (u, v) ∈ [symbol] × [symbol] ³ We can also construct N² pairs (t, s) ∈ [symbol] We can estimate the pairs of conditional probabilities Pr(v|y), Pr(y|u) and Pr(s|z), Pr(z|t) using the EM algorithm. For Pr(v|y) and Pr(y|u) we have ³If u and v are two distinct members of εₗ, we would construct the pairs (u; v), (v; u), (u; u), and (v; v).

E-Step:

$${{Q}^{*} ( y \vert u , v , {θ}^{-} )}^{+} = \frac{{Pr ( v \vert y )}^{-} {Pr ( y \vert u )}^{\_}}{{\sum }_{y ∈ 𝒴} Pr ( v \vert y ) Pr ( y \vert u )} \qquad ( 18 )$$

M-Step:

$$\begin{matrix}{Pr ( v \vert y )}^{+} = \frac{{\sum }_{( u , v ) ∈ {𝒟}_{ɛ} ( \cdot , v )} {{Q}^{*} ( y \vert u , v , {θ}^{-} )}^{+}}{{\sum }_{( u , v ) ∈ {𝒟}_{ɛ}} {{Q}^{*} ( y \vert u , v , {θ}^{-} )}^{+}} & ( 19 ) \\ {Pr ( y \vert u )}^{+} = \frac{{\sum }_{( u , v ) ∈ {𝒟}_{ɛ} ( u , \cdot )} {{Q}^{*} ( y \vert u , v , {θ}^{-} )}^{+}}{{\sum }_{y ∈ Y} {\sum }_{( u , v ) ∈ {𝒟}_{ɛ} ( u , \cdot )} {{Q}^{*} ( y \vert u , u , {θ}^{-} )}^{+}} & ( 20 )\end{matrix}$$

where [symbol] ε is the collection of all co-occurrence pairs (u, v) constructed from all lists εₗ ∈ε. [symbol] ε (u,·) and [symbol] ε(·, v) denote the subsets of such pairs with the specified user u as the first member and the specified user v as the second member, respectively. Similarly, for Pr(s|z) and Pr(z|t) we have

E-Step:

$${{Q}^{*} ( x \vert t , s , {ψ}^{-} )}^{+} = \frac{{Pr ( s \vert z )}^{-} {Pr ( z \vert t )}^{-}}{{\sum }_{z ∈ Z} {Pr ( s \vert z )}^{-} {Pr ( z \vert t )}^{-}} \qquad ( 21 )$$

M-Step:

$$\begin{matrix}{Pr ( s \vert z )}^{+} = \frac{{\sum }_{( t , o ) ∈ {𝒟}_{ℱ} ( \cdot , o )} {{Q}^{*} ( z \vert t , s , {ψ}^{-} )}^{+}}{{\sum }_{( t , s ) ∈ {𝒟}_{ℱ}} {{Q}^{*} ( z \vert t , s , {ψ}^{-} )}^{+}} & ( 22 ) \\ {Pr ( z \vert t )}^{+} = \frac{{\sum }_{( t , s ) ∈ {𝒟}_{ℱ} ( t , \cdot )} {{Q}^{*} ( z \vert t , s , {ψ}^{-} )}^{-}}{{\sum }_{z ∈ Z} {\sum }_{( t , s ) ∈ {𝒟}_{ℱ} ( t , \cdot )} {{Q}^{*} ( z \vert t , s , {ψ}^{-} )}^{+}} & ( 23 )\end{matrix}$$

While the preceding two approaches may be adequate for many applications, both may not explicitly incorporate incremental addition of new input data. The iterative computations (18), (19), (20) and (21), (22), (24) assume the input data set is known and fixed at the outset. As we noted above, some recommenders incorporate new input data in an ad hoc fashion. We can extend the basic PLSI algorithm to more effectively incorporate sequential input data for another approach to computing the user community and item collection conditionals.

Focusing first on the conditionals Pr(v|y) and Pr(y|u), there are several ways we could incorporate sequential input data into an EM algorithm for computing time-varying conditionals Pr(v|y; τₙ)⁺, Pr(y|u; τₙ)⁺, and Q*(y|u, v, θ⁻; τₙ)⁺ We only describe one simple method here in which we also gradually de-emphasize older data as we incorporate new data. We first define two time-varying co-occurrence matrices ΔE(τₙ) and ΔF(τₙ) of the data pairs received since time τₙ₋₁ with elements

Δeᵥᵤ(τₙ)−|{(u,v)|(u,v)∈D_{ε}(τₙ)−D_{ε}(τₙ₋₁)}|Δfₐₜ(τₙ)=|{(t,s)|(t,s)∈D_{F}(τₙ)−D_{ε}(τₙ₋₁)}|

We then add two additional initial steps to the basic EM algorithm so that the extended computation consists of four steps. The first two steps are done only once before the E and M steps are iterated until the estimates for Pr(v|y; τₙ) and Pr(y|u; τₙ) converge:

W-Step: The initial “Weighting” step computes an appropriate weighted estimate for the co-occurrence matrix E(τₙ). The simplest method for doing this is to compute a suitably weighted sum of the older data with the latest data

E(τₙ)=αεE(τₙ₋₁)+β_{ε}ΔE(τₙ) (25)

This difference equation has the solution

$$E ( {τ}_{n} ) = {β}_{E} {\sum }_{i = 0}^{¨} {α}_{ɛ}^{- ( n - i )} Δ E ( {t}_{i} )$$

(25) is just a scaled discrete integrator for α_{ε}=1. Choosing 0≦α_{ε}<1 and setting β_{ε}=1−α_{ε} gives a simple linear estimator for the mean value of the co-occurrence matrix that emphasizes the most recent data.

I-Step: In the next “Input” step, the estimated co-occurrence data is incorporated in the EM computation. This can be done in multiple ways, one straightforward approach is to adjust the starting values for the EM phase of the algorithm by re-expressing the M-step computations (19) and (20) in terms of E(τₙ), and then re-estimating the conditionals Pr(v|y; τₙ)⁻ and Pr(y|u; τₙ)⁻at time τₙ

$$\begin{matrix}{Pr ( v \vert y ; {τ}_{n} )}^{-} = \frac{{\sum }_{u} {e}_{vu} ( {τ}_{n} ) {{Q}^{*} ( y \vert u , v , {θ}^{-} ; {τ}_{n - 1} )}^{+}}{{\sum }_{v} {\sum }_{u} {e}_{vu} ( {τ}_{n} ) {{Q}^{*} ( y \vert u , v , {θ}^{-} ; {τ}_{n - 1} )}^{+}} & ( 26 ) \\ {Pr ( y \vert u ; {ψ}_{n} )}^{-} = \frac{{\sum }_{v} {e}_{vu} ( {τ}_{n} ) {{Q}^{*} ( y \vert u , v , {θ}^{-} ; {τ}_{n - 1} )}^{+}}{{\sum }_{v ∈ = V} {\sum }_{n} {e}_{vu} ( {τ}_{n} ) {{Q}^{*} ( y \vert u , v , {θ}^{-} ; {τ}_{n - 1} )}^{+}} & ( 27 )\end{matrix}$$

E-Step: The EM iteration consists of the same E-step and M-step as the basic algorithm. The E-step computation is

$${{Q}^{*} ( y \vert u , v , {θ}^{-} ; {τ}_{n} )}^{+} = \frac{{Pr ( v \vert y ; {τ}_{n} )}^{-} {Pr ( y \vert u ; {τ}_{n} )}^{-}}{{\sum }_{y ∈ Y} {Pr ( v \vert y ; {τ}_{n} )}^{-} {Pr ( y \vert u ; {τ}_{n} )}^{-}} \qquad ( 28 )$$

M-step: Finally, the M-step computation is

$$\begin{matrix}{Pr ( v \vert y ; {τ}_{n} )}^{+} = \frac{{\sum }_{u} {e}_{vu} ( {τ}_{n} ) {{Q}^{*} ( y \vert u , v , {θ}^{-} ; {τ}_{n} )}^{+}}{{\sum }_{v} {\sum }_{u} {e}_{vu} ( {τ}_{n} ) {{Q}^{*} ( y \vert u , v , {θ}^{-} ; {τ}_{n} )}^{+}} & ( 29 ) \\ {Pr ( y \vert u ; {τ}_{n} )}^{+} = \frac{{\sum }_{v} {e}_{vu} ( {τ}_{n} ) {{Q}^{*} ( y \vert u , v , {θ}^{-} ; {τ}_{n} )}^{+}}{{\sum }_{y ∈ Y} {\sum }_{v} {e}_{vu} ( {τ}_{n} ) {{Q}^{*} ( y \vert u , v , {θ}^{-} ; {τ}_{n} )}^{+}} & ( 30 )\end{matrix}$$

Convergence of the EM iteration in this extended algorithm is guaranteed since this algorithm only changes the starting values for the EM iteration.

The extended algorithm for computing Pr(s|z) and Pr(z|t) is analogous to the algorithm for computing Pr(v|y) and Pr(y|u):

W-Step: Given input data ΔF(τₙ), the estimated co-occurrence data is computed as

F(τₙ)=α_{F}F(τₙ₋₁)+β_{F}ΔF(τₙ) (31)

I-Step:

$$\begin{matrix}{Pr ( s \vert z ; {τ}_{n} )}^{-} = \frac{{\sum }_{t} {f}_{st} ( {τ}_{n} ) {{Q}^{*} ( z \vert t , s , {ψ}^{-} ; {τ}_{n - 1} )}^{+}}{{\sum }_{s} {\sum }_{t} {f}_{st} ( {τ}_{n} ) {{Q}^{*} ( z \vert t , s , {ψ}^{-} ; {τ}_{n - 1} )}^{+}} & ( 32 ) \\ {Pr ( z \vert t ; {τ}_{n} )}^{-} = \frac{{\sum }_{s} {f}_{st} ( {τ}_{n} ) {{Q}^{*} ( z \vert t , s , {ψ}^{-} ; {τ}_{n - 1} )}^{+}}{{\sum }_{z ∈ Z} {\sum }_{s} {f}_{st} ( {τ}_{n} ) {{Q}^{*} ( z \vert t , s , {ψ}^{-} ; {τ}_{n - 1} )}^{+}} & ( 33 )\end{matrix}$$

E-Step:

$${{Q}^{*} ( z \vert t , s , {ψ}^{-} ; {τ}_{n} )}^{+} = \frac{{Pr ( s \vert z ; {τ}_{n} )}^{-} {Pr ( z \vert t ; {τ}_{n} )}^{-}}{{\sum }_{z ∈ Z} {Pr ( s \vert x ; {τ}_{n} )}^{-} {Pr ( z \vert t ; {τ}_{n} )}^{-}} \qquad ( 35 )$$

M-Step:

$$\begin{matrix}{Pr ( s \vert z ; {τ}_{n} )}^{+} = \frac{{\sum }_{t} {f}_{st} ( {τ}_{n} ) {{Q}^{*} ( z \vert t , s , {ψ}^{-} ; {τ}_{n} )}^{+}}{{\sum }_{s} {\sum }_{t} {f}_{st} ( {τ}_{n} ) {{Q}^{*} ( z \vert t , s , {ψ}^{-} ; {τ}_{n} )}^{+}} & ( 36 ) \\ {Pr ( z \vert t ; {τ}_{n} )}^{+} = \frac{{\sum }_{s} {f}_{st} ( {τ}_{n} ) {{Q}^{*} ( z \vert t , s , {ψ}^{-} ; {τ}_{n} )}^{+}}{{\sum }_{z ∈ Z} {\sum }_{s} {f}_{st} ( {τ}_{n} ) {{Q}^{*} ( z \vert t , s , {ψ}^{-} ; {τ}_{n} )}^{+}} & ( 37 )\end{matrix}$$

Association Conditionals

Once we have estimates for Pr(s|z; τₙ) and Pr(y|u; τₙ), we can derive estimates for the association conditionals Pr(z|y; τₙ) expressing the probabilistic relationships between the user communities y ∈γ and item collections z ∈ [symbol] These estimates must be derived from the lists [symbol] since this is the only observed data that relates users and items. A key simplifying assumption in the model we build here is that

$$Pr ( s , S \vert z ) = Pr ( s \vert z ) {\prod }_{{s}^{′} ∈ S} Pr ( {s}^{′} \vert z ) \qquad ( 39 )$$

Appendix C presents a full derivation of E-step (49) and M-step (53) of the basic EM algorithm for estimating Pr(z|y). Defining the list of seeds S in the triples (u, s, S) is needed in the M-step computation. In some cases, the seeds S could be independent and supplied with the list. For these cases, the input data [symbol] from the user lists [symbol] would be

[symbol]

={(u_{i*},sᵢ_{₁},S), . . . , (u_{i*},sᵢ_{ₙ},S)} (40)

In other cases, the seeds might be inferred from the items in the user list Hᵢ itself. These could be just the items preceding each item in the list so that the input data would be

[symbol]

={(u_{i*},sᵢ_{₁},Sᵢ_{₁}=0),(u_{i*},sᵢ_{₂},Sᵢ_{₂}32 {sᵢ_{₁}}), . . . ,(u_{i*},sᵢ_{ₙ},Sᵢ_{ₙ}={sᵢ_{₁}, . . . ,sₙ₋₁})} (41)

The seeds for each (u, s) pair in the list could also be every other item in the list, in this case

[symbol]

ᵢ={(u_{i*},sᵢ_{₁},Sᵢ_{₁}=S−{sᵢ_{₁}}, . . . ,(u_{i*},sᵢ_{ₙ},Sᵢ_{ₙ}=S−{sᵢ_{ₙ}})} (42)

As we did for the user community conditional Pr(y|u) and item collection conditional Pr(s|z), we can also extend this EM algorithm to incorporate sequential input data. However, instead of forming data matrices, we define two time-varying data lists Δ [symbol] (τₙ) and Δ [symbol] (τₙ) from the bag of lists [symbol] (τₙ)

Δ [symbol] (τₙ)={(u,s,S,h)|(u,s,h,)∈ [symbol] ᵢ, [symbol] ᵢ∈ [symbol] (τₙ), [symbol] ∉ [symbol] τₙ₋₁)}Δ [symbol] (τₙ)={(u u,s,S,1)|(u,s,S,h)∈ΔD(τₙ)}

where the seeds S for each item are computed by one of the methods (40), (41), (42) or any other desired method. We also note that Δ [symbol] (τₙ) and Δ [symbol] (τₙ) are bags, meaning they include an instance of the appropriate tuple for each instance of the defining tuple in the description. The extended EM algorithm for computing Pr(z|y; τ) then incorporates appropriate versions of the initial W-step and I-step computations into the basic EM computations:

W-Step: The weighting factors are applied directly to the list [symbol] (τₙ₋₁) and the new data list Δ [symbol] (τₙ) to create the new list

[symbol]

(τₙ)={(u,s,S,aa)|(u,s,S,a)∈ [symbol] (τₙ₋₁)}∪{(u,s,S,βa)|(u,s,S,a)∈Δ [symbol] (τₙ)} (43)

I-Step: The weighted data at time τₙ is incorporated into the EM computation via the weighting coefficient a from each tuple (u, s, S, a) to re-estimate Pr(z|y; τₙ₋₁)⁺ as Pr(z|y; τₙ)⁻

$${Pr ( z \vert y ; {τ}_{n} )}^{-} = \frac{{\sum }_{( u , s , S , a ) ∈ A ( {τ}_{n} )} {{aQ}^{*} ( z , y \vert s , S , u , {ψ}^{-} ; {τ}_{n - 1} )}^{+}}{{\sum }_{z ∈ Z} {\sum }_{( u , s , S , a ) ∈ A ( {τ}_{n} )} {{aQ}^{*} ( z , y \vert s , S , u , {φ}^{-} ; {τ}_{n - 1} )}^{+}} \qquad ( 44 )$$

We note, however, that we may have Q*(z, y|s, S, u, θ⁻; τₙ₋₁)⁺=0 for (u, s, S, a) that are in [symbol] (τₙ) but such that (u, s, S, a′) is not in [symbol] (τₙ₋₁). This missing data is filled by the first iteration of the following E-step.

E-Step:

$${{Q}^{*} ( z , y \vert s , S , u , {φ}^{-} ; {τ}_{n} )}^{+} = \frac{[ \begin{matrix}Pr ( s \vert z ; {τ}_{n} ) {\prod }_{{s}^{′} ∈ S} \\ Pr ( {s}^{′} \vert z ; {τ}_{n} ) Pr ( yu ; {τ}_{n} )\end{matrix} ] {Pr ( z \vert y ; {τ}_{n} )}^{-}}{{\sum }_{z ∈ Z} {\sum }_{u ∈ Y} [ \begin{matrix}Pr ( s \vert z ; {τ}_{n} ) {\prod }_{{s}^{′} ∈ S} \\ Pr ( {s}^{′} \vert z ; {τ}_{n} ) Pr ( y \vert u ; {τ}_{n} )\end{matrix} ] {Pr ( z \vert y ; {τ}_{n} )}^{-}} \qquad ( 45 )$$

M-Step:

$${Pr ( z \vert y ; {τ}_{n} )}^{+} = \frac{{\sum }_{( u , a , S , a ) ∈ A ( {τ}_{n} )} {{aQ}^{*} ( z , y \vert s , S , u , {φ}^{-} ; {τ}_{n} )}^{+}}{{\sum }_{z ∈ Z} {\sum }_{( u , s , S , a ) ∈ A ( {τ}_{n} )} {{aQ}^{*} ( z , y \vert s , S , u , {φ}^{-} ; {τ}_{n} )}^{+}} \qquad ( 46 )$$

Memory-based recommenders are not well suited to explicitly incorporating independent, a priori knowledge about user communities and item collections. One type of user community and item collection information is implicit in some model-based recommenders. However, some recommenders' data models do not provide the needed flexibility to accommodate notions for such clusters or groupings other than item selection behavior. In some recommnenders, additional knowledge about item collections is incorporated in an ad hoc way via supplementary algorithms.

In an embodiment, the model-based recommender we describe above allows user community and item collection information to be specified explicitly as a priori constraints on recommendations. The probabilities that users in a community are interested in the items in a collection are independently learned from collections of user communities, item collections, and user selections. In addition, the system learns these probabilities by an adaptive EM algorithm that extends the basic EM algorithm to better capture the time-varying nature of these sources of knowledge. The recommender that we describe above is inherently massively-scalable. It is well suited to implementation as a data-center scale Map-Reduce computation. The computations to produce the knowledge base can be run as an off-line batch operation and only recommendations computed in real-time on-line, or the entire process can be run as a continuous update operation. Finally, it is possible and practical to run multiple recommendation instances with knowledge bases built from different sets of user communities and item collections as a multi-criteria meta-recommender.

Exemplary Pseudo Code

Process: INFER_COLLECTIONS

Description:

To construct time-varying latent collections c₁(τₙ), c₂(τₙ), . . . , cₖ(τₙ), given a time-varying list D(τₙ) of pairs (aᵢ, bⱼ). The collections cₖ(τₙ) are implicitly specified by the probabilities Pr(cₖ|aᵢ: τₙ) and Pr(bⱼ|cₖ; τₙ).

Input:
A) List D(τₙ).
B) Previous probabilities Pr(cₖ|aᵢ; τₙ₋₁) and Pr(bⱼ|cₖ; τₙ₋₁).
C) Previous conditional probabilities Q*(cₖ|aᵢ, bⱼ; τₙ₋).
D) Previous list E(τₙ₋₁) of triples (aᵢ, bⱼ, eᵢⱼ) representing weighted, accumulated input lists.

Output:
A) Updated probabilities Pr(cₖ|aᵢ; τₙ) and Pr(bⱼ|cₖ; τₙ).
B) Conditional probabilities Q*(cₖ|aᵢ, bⱼ; τₙ).
C) Updated list E(τₙ) of triples (aᵢ, bⱼ, eᵢⱼ) representing weighted, accumulated input lists.

Exemplary Method:
1) (W-step) Create the updated list E(τₙ) incorporating the new pairs D(τₙ) into E(τₙ₋₁):
   a) Let E(τₙ) be the empty list.
   b) For each triple (aᵢ, bⱼ, eᵢⱼ) in E(τₙ₋₁), add (aᵢ, bⱼ, αeᵢⱼ) to E(τₙ).
   c) For each pair (aᵢ, bⱼ) in D(τₙ):
      i. If (aᵢ, bⱼ, eᵢⱼ) in E(τₙ), replace (aᵢ, bⱼ, eᵢⱼ) with (aᵢ, bⱼ, e_{ij +β).}
      ii. Otherwise, add (aᵢ, bⱼ, β) to E(τₙ).
2) (I-step) Initially re-estimate the probabilities Pr(cₖ|aᵢ; τₙ)⁻ and Pr(bⱼ|cₖ; τₙ)⁻ using E(τₙ) and the conditional probabilities Q*(cₖ|aᵢ, bⱼ; τₙ₋₁):
   a) For each cₖ and each (aᵢ, bⱼ, eᵢⱼ) in E(τₙ), estimate Pr(bⱼ|cₖ; τₙ)⁻:
      i. Let Pr_{N} be the sum across aᵢ′ of eᵢⱼ Q*(cₖ|aᵢ′, bⱼ; τₙ₋₁).
      ii. Let Pr_{D} be the sum across aᵢ′ and bⱼ′ of eᵢⱼ Q*(cₖ|aᵢ′, bⱼ′; τₙ₋₁).
      iii. Let Pr(bⱼ|cₖ; τₙ)³¹ be Pr_{N}/Pr_{D}.
   b) For each cₖ and each (aᵢ, bⱼ, eᵢⱼ) in E(τₙ), estimate Pr(cₖ|aᵢ; τₙ)⁻:
      i. Let Pr_{N} be the sum across bⱼ′ of eᵢⱼ Q*(cₖ|aᵢ, bⱼ′; τₙ₋₁).
      ii. Let Pr_{D} be the sum across cₖ ′ and bⱼ′ of eᵢⱼ Q*(cₖ′|aᵢ, bⱼ′; τₙ₋₁).
      iii. Let Pr(cₖ|aᵢ; τₙ)⁻ be Pr_{N}/Pr_{D}.
3) (E-step) Estimate the new conditionals Q*(cₖ|aᵢ, bⱼ; τₙ):
   a) For each cₖ and each (aᵢ, bⱼ, eᵢⱼ) in E(τₙ), estimate the conditional probability Q*(cₖ|aᵢ, bⱼ; τₙ):
      i. Let Q*_{D} be the sum across cₖ′ of Pr(bⱼ|cₖ′; τₙ)⁻Pr(cₖ′|aᵢ; τₙ)⁻.
      ii. Let Q*(cₖ|aᵢ, bⱼ; τₙ) be Pr(bⱼ|cₖ; τₙ)⁻Pr(cₖ|aᵢ; τₙ)⁻/Q*_{D}.
4) (M-step) Estimate the new probabilities Pr(cₖ|aᵢ; τₙ)⁺ and Pr(bⱼ|cₖ; τₙ)⁺:
   a) For each cₖ and each (aᵢ, bⱼ, eᵢⱼ) in E(τₙ), estimate Pr(bⱼ|cₖ; τₙ)⁻:
      i. Let Pr_{N} be the sum across aᵢ′ of eᵢⱼ Q*(cₖ|aᵢ′, bⱼ; τₙ).
      ii. Let Pr_{D} be the sum across aᵢ′ and bⱼ′ of eᵢⱼ Q*(cₖ|aᵢ′, bⱼ′; τₙ).
      iii. Let Pr(bⱼ|cₖ; τₙ)⁺ be Pr_{N}/Pr_{D}.
   b) For each cₖ and each (aᵢ, bⱼ, eᵢⱼ) in E(τₙ), estimate Pr(cₖ|aᵢ; τₙ)⁺:
      i. Let Pr_{N} be the sum across bⱼ′ of eᵢⱼ Q*(cₖ|aᵢ, bⱼ′; τₙ).
      ii. Let Pr_{D} be the sum across cₖ′ and bⱼ′ of eᵢⱼ Q*(cₖ′|aᵢ, bⱼ′; τₙ).
      iii. Let Pr(cₖ|aᵢ; τₙ)⁺ be Pr_{N}/Pr_{D}.
5) If |Pr(bⱼ|cₖ; τₙ)⁻−Pr(bⱼ|cₖ; τₙ)⁺|>d or |Pr(cₖ|aᵢ; τₙ)⁻−Pr(cₖ|aᵢ, τₙ)⁺|>d for a pre-specified d<<1, repeat E-step (3.) and M-step (4.) with Pr(bⱼ|cₖ; τₙ)⁻=Pr(bⱼ|cₖ; τₙ)⁺ and Pr(cₖ|aᵢ; τₙ)⁻=Pr(cₖ|aᵢ; τₙ)⁺.
6) Return updated probabilities Pr(cₖ|aᵢ; τₙ)=Pr(cₖ|aᵢ; τₙ)⁺ and Pr(bⱼ|cₖ; τₙ) =Pr(bⱼ|cₖ; τₙ)⁺, along with conditional probabilities Q*(cₖ|aᵢ, bⱼ; τₙ), and updated list E(τₙ) of triples (aᵢ, bⱼ, eᵢⱼ).

Notes:
A) In one embodiment, α and β in the W-step (1. ) are assumed to be constants specified a priori.
B) In the I-step (2. ), Q*(cₖ|aₚ, bⱼ; τₙ)=0 if Q*(cₖ|aₚ, bⱼ; τₙ₋) does not exist from the previous iteration.

Process: INFER_ASSOCIATIONS

Description:

To construct time-varying association probabilities Pr(zₖ|yₗ; τₙ) between two collections z₁(τₙ), z₂(τₙ), . . . , zₖ(τₙ) and y₁(τₙ), y₂(τₙ), . . . , yₗ(τₙ) of items, given the probabilities Pr(yₖ|uᵢ; τₙ) that the uᵢ are members of the collections yₗ(τₙ), the probabilities Pr(sⱼ|zₗ; τₙ) that the collections zₖ(τₙ) include the sⱼ as members, and a time-varying list D(τₙ) of triples (uᵢ, sⱼ, Sₒ).

Input:
A) Probabilities Pr(yₗ|uᵢ; τₙ) and Pr(sⱼ|zₖ; τₙ).
B) List D(τₙ).
C) Previous probabilities Pr(zₖ|yₗ; τₙ₋₁).
D) Previous list E(τₙ₋₁) of 4-tuples (uᵢ, sⱼ, Sₒ, eᵢⱼₒ) representing weighted, accumulated input lists.
E) Previous conditional probabilities Q*(zₖ, yₗ|uᵢ, sⱼ, Sₒ; τₙ₋₁).

Output:
A) Updated probabilities Pr(zₖ|yₗ; τₙ).
B) Updated list E(τₙ) of 4-tuples (uᵢ, sⱼ, Sₒ, eᵢⱼₒ) representing weighted, accumulated input lists.
C) Conditional probabilities Q*(zₖ|yₗ|uᵢ, sⱼ, Sₒ; τₙ).

Exemplary Method:
1) (W-step) Create the updated list E(τₙ) incorporating the new triples D(τₙ) into E(τₙ₋₁):
   a) Let E(τₙ) be the empty list.
   b) For each 4-tuple (uᵢ, sⱼ, Sₒ, eᵢⱼₒ) in E(τₙ₋₁), add (uᵢ, sⱼ, Sₒ, αeⱼᵢ) to E(τₙ).
   c) For each triple (uᵢ, sⱼ, Sₒ) in D(τₙ):
      i. If (uᵢ, sⱼ, Sₒ, eᵢⱼₒ) in E(τₙ), replace (uᵢ, sⱼ, Sₒ, eᵢⱼₒ) with (uᵢ, sⱼ, Sₒ, eᵢⱼₒ+β).
      ii. Otherwise, add (uᵢ, sⱼ, Sₒ, β) to E(τₙ).
2) (I-step) Initially estimate the probabilities Pr(zₖ|yₗ; τₙ) using E(τₙ) and the conditional probabilities Q*(zₖ, yₗ|uᵢ, sⱼ, Sₒ; τₙ).
   a) For each yₗ and zₖ, estimate Pr(zₖ|yₗ; τₙ)⁻:
      i. Let Pr_{N} be the sum across uᵢ, sⱼ, and Sₒ of eᵢⱼₒ Q*(zₖ,yₗ|uᵢ, sⱼ, Sₒ; τₙ₋₁).
      ii. Let Pr_{D} be the sum across uᵢ, sⱼ, Sₒ and zₖ′ of eᵢⱼₒ Q*(zₖ, yₗ|uᵢ, sⱼ, Sₒ; τₙ₋₁).
      iii. Let Pr(zₖ|yₗ; τₙ)³¹ be Pr_{N}/Pr_{D}.
3) (E-step) Estimate the new conditionals Q*(zₖ, yₗ|uᵢ, sⱼ, Sₒ; τₙ):
   a) For each yₗ and zₖ, estimate the conditional probability Q*(zₖ, yₗ|uᵢ, sⱼ, Sₒ; τₙ):
      i. Let Q*ₛ be the total product of Pr(sⱼ|zₖ; τₙ)⁻, the product across sⱼ′ of Pr(sⱼ′|zₖ; τₙ)⁻, and Pr(yₗ|uᵢ; τₙ)⁻.
      ii. Let Q*_{D} be the sum across yₗ′ and zₖ′ of Q*ₛ Pr(zₖ′|yₗ; τₙ)⁻.
      iii. Let Q*(zₖ, yₗ|uᵢ, sⱼ, Sₒ; τₙ) be Q*ₛ Pr(zₖ|yₗ; τₙ)⁻/Q*_{D}.
4) (M-step) Estimate the new probabilities Pr(zₖ|yₗ; τₙ)⁺:
   a) For each yₗ and zₖ, estimate Pr(zₖ|yₗ; τₙ)⁺:
      i. Let Pr_{N} be the sum across uᵢ, sⱼ, and Sₒ of eᵢⱼₒ Q*(zₖ, yₗ|uᵢ, sⱼ, Sₒ; τₙ).
      ii. Let Pr_{D} be the sum across uᵢ, sⱼ, Sₒ and zₖ′ of eᵢⱼₒ Q*(zₖ′, yₗ|uᵢ, sⱼ, Sₒ; τₙ).
      iii. Let Pr(zₖ|yₗ; τₙ)⁺ be Pr_{N}/Pr_{D}.
5) If, for any pair (zₖ, yₗ), |Pr(zₖ|yₗ; τₙ)⁻−Pr(zₖ|yₗ; τₙ)⁺|>d for a pre-specified d <<1, and the E-step (3.) and M-step (4.) and not been repeated more than some number R times, repeat E-step (3.) and M-step (4.) with Pr(zₖ|yₗ; τₙ) Pr(zₖ|yₗ; τₙ)⁺.
6) For any pair (zₖ, yₗ), |Pr(zₖ|yₗ; τₙ)⁻−Pr(zₖ|yₗ; τₙ)⁺|>d for a pre-specified d <<1, let Pr(zₖ|yₗ; τₙ)⁺=[Pr(zₖ|yₗ; τₙ)⁻+Pr(zₖ|y₁; τₙ)⁺]/2.
7) Return updated probabilities Pr(zₖ|yₗ; τₙ)=Pr(zₖ|yₗ; τₙ)⁺, along with conditional probabilities Q*(zₖ, yₗ|uᵢ, sⱼ, Sₒ; τₙ), and updated list E(τₙ) of 4-tuples (uᵢ, sⱼ, Sₒ, eᵢⱼₒ).

Notes:
A) There potentially are combinations of triples (uᵢ, sⱼ, Sₒ) such that the process does not produce valid Pr(zₖ|yₗ; τₙ).
B) The α and β in the W-step (1.) are assumed to be constants specified a priori.
C) In the I-step (2.), Q*(zₗ|yₖ|uᵢ, sⱼ, Sₒ; τₙ₋₁)=0 if Q*(zₖ, yₖ|uᵢ, sⱼ, Sₒ; τₙ₋₁) does not exist from the previous iteration.

Process: CONSTRUCT_MODEL

Description:

To construct a model for time-varying lists Dᵤᵥ(τₙ) of user-user pairs (uᵢ, vⱼ), Dₜₛ(τₙ) of item-item pairs (tᵢ, sⱼ), and Dᵤₛ(τₙ) of user-item triples (uᵢ, sⱼ, Sₒ) that groups users uᵢ into communities of items yₗ and items sⱼ into communities of items sₖ. The model is specified by the probabilities Pr(yₗ|uᵢ; τₙ) that the uᵢ are members of the collections yₗ(τₙ), the probabilities Pr(sⱼ|zₖ; τₙ) that the collections zₖ(τₙ) include the sⱼ as members, and the probabilities Pr(zₖ|yₗ; τₙ) that the communities yₗ(τₙ) are associated with the collections zₖ(τₙ).

Input:
A) Lists Dᵤᵥ(τₙ), Dₜₛ(τₙ), and Dᵤₛ(τₙ).
B) Previous probabilities Pr(yₗ|uᵢ; τₙ₋₁), Pr(zₖ|yₗ; τₙ₋₁), and Pr(sⱼ|zₖ; τₙ₋₁).
C) Previous lists Eᵤᵥ(τₙ₋₁) of triples (uᵢ, vⱼ, eᵢⱼ), Eₜₛ(τₙ₋₁) of triples (tᵢ, sⱼ, eᵢⱼ), and Eᵤₛ(τ₋₁) of 4-tuples (uᵢ, sⱼ, Sₒ, eᵢⱼₒ) representing weighted, accumulated input lists.
D) Previous conditional probabilities Q*(yₗ|uᵢ, vⱼ; τₙ₋₁), Q*(zₖ|tᵢ, sⱼ; τₙ₋₁), and Q*(zₖ|uᵢ, sⱼ, Sₒ; τₙ₋₁).

Output:
A) Updated probabilities Pr(yₗ|uᵢ; τₙ), Pr(zₖ|yₗ; τₙ), and Pr(sᵢ|zₖ; τₙ).
B) Conditional probabilities Q*(yₗ|uᵢ, vⱼ; τₙ₋₁), Q*(zₖ, |tᵢ, sⱼ; τₙ₋₁), and Q*(zₖ, yₗ|uᵢ, sⱼ, Sₒ; τₙ₋₁).
C) Updated lists Eᵤᵥ(τₙ) of triples (uᵢ, vⱼ, eᵢⱼ), Eₜₛ(τₙ) of triples (tᵢ, sⱼ, eᵢⱼ), and Eᵤₛ(τₙ) of 4-tuples (uᵢ, sⱼ, Sₒ, eᵢⱼₒ) representing weighted, accumulated input lists.

Exemplary Method:
1) Construct user communities y₁(τₙ), y₂(τₙ), . . . , yₗ(τₙ) by the process INFER_COLLECTIONS.
   Let Dᵤᵥ(τₙ), Pr(yₗ|uᵢ; τₙ₋₁), Pr(vᵢ|yₗ; τₙ₋₁), Q*(yₗ|uᵢ, vⱼ; τₙ₋₁), and Eᵤᵥ(τₙ₋₁) be the inputs D(τₙ), Pr(cₖ|aᵢ; τₙ₋₁), Pr(bⱼ|cₖ; τₙ₋₁), Q*(yₗ|uᵢ, vⱼ; τₙ₋₁), and E(τₙ₋₁), respectively.
   Let Pr(yₗ|uᵢ; τₙ), Pr(vⱼ|yₗ; τₙ), Q*(yₗ|uⱼ, vⱼ; τₙ), and Eᵤᵥ(τₙ) be the outputs Pr(cₖ|aᵢ; τₙ), Pr(bⱼ|cₖ; τₙ), Q*(yₗ|uᵢ, vⱼ; τₙ), and E(τₙ), respectively.
2) Construct item collections z₁(τₙ), z₂(τₙ), . . . , zₖ(τₙ) by the process INFER_COLLECTIONS.
   Let Dₜₛ(τₙ), Pr(zₖ|tⱼ; τₙ₋₁), Pr(sⱼ|zₖ; τₙ₋₁), Q*(zₖ|tᵢ, sⱼ; τₙ₋₁), and Eₛₜ(τₙ₋₁) be the inputs D(τₙ), Pr(cₖ|aᵢ; τₙ₋₁), Pr(bⱼ|cₖ; τₙ₋₁), Q*(yₗ|uᵢ, vⱼ; τₙ₋₁), and E(τₙ₋₁), respectively.
   Let Pr(zₖ|tⱼ; τₙ), Pr(sⱼ|zₖ; τₙ), Q*(zₖ|tᵢ, aⱼ; τₙ), and Eₛₜ(τₙ) be the outputs Pr(cₖ|aᵢ; τₙ), Pr(bⱼ|cₖ; τₙ), Q*(yₗ|uᵢ, vⱼ; τₙ), and E(τₙ), respectively.
3) Estimate the associations between user communities and item collections by the process INFER_ASSOCIATIONS:
   Let Pr(yₗ|uᵢ; τₙ), Pr(zₖ|tⱼ; τₙ), Dᵤₛ(τₙ), Pr(zₖ|yₗ; τₙ), Eᵤᵥ(τₙ₋₁), and Q*(zₖ, yₗ|uᵢ, sⱼ, Sₒ; τₙ₋₁) be the inputs.
   Let Pr(zₖ|yₗ; τₙ), Eᵤᵥ(τₙ), and Q*(zₖ|uᵢ, sⱼ, Sₒ; τₙ) be the outputs.

Notes:
A) The process may optionally be initialized with estimates for the user communities and item collections, in the form of the probabilities Pr(yₗ|uᵢ; τ₋₁), Pr(vⱼ|yₗ; τ₋₁) and the probabilities Pr(zₖ|tⱼ; τ₋₁), Pr(sⱼ|zₖ; τ₋₁), and using the process INFER_COLLECTIONS without inputs Dᵤᵥ(τₙ) and Dₜₛ(τₙ) to re-estimate the probabilities Pr(yₗ|uᵢ; τ₋₁), Pr(vⱼ|yₗ; τ₋₁), Q*(yₗ|uᵢ, vⱼ; τ₋₁), and the probabilities Pr(zₖ|tⱼ; τ₋₁), Pr(sⱼ|zₖ; τ₋₁), Q*(zₖ|tᵢ, aⱼ; τ₋₁).
B) Alternatively, the estimated user communities and item collections may be supplemented with additional fixed user communities and item collections, in the form of fixed probabilities Pr(yₗ|uᵢ; ·), Pr(zₖ|tⱼ; ·), in the input to the INFER_ASSOCIATIONS process.

Exemplary System

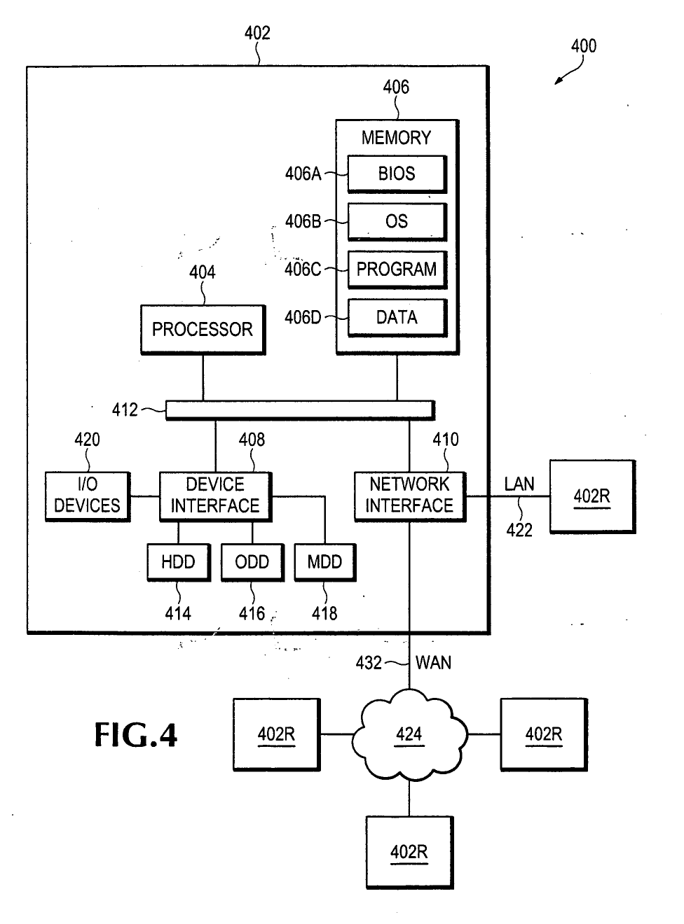

The recommenders we describe above may be implemented on any number of computer systems, for use by one or more users, including the exemplary system 400 shown in FIG. 4. Referring to FIG. 4, the system 400 includes a general purpose or personal computer 302 that executes one or more instructions of one or more application programs or modules stored in system memory, e.g., memory 406. The application programs or modules may include routines, programs, objects, components, data structures, and like that perform particular tasks or implement particular abstract data types. A person of reasonable skill in the art will recognize that many of the methods or concepts associated with the above recommender, that we describe at times algorithmically may be instantiated or implemented as computer instructions, firmware, or software in any of a variety of architectures to achieve the same or equivalent result.

Moreover, a person of reasonable skill in the art will recognize that the recommender we describe above may be implemented on other computer system configurations including hand-held devices, multi-processor systems, microprocessor-based or programmable consumer electronics, minicomputers, mainframe computers, application specific integrated circuits, and like. Similarly, a person of reasonable skill in the art will recognize that the recommender we describe above may be implemented in a distributed computing system in which various computing entities or devices, often geographically remote from one another, perform particular tasks or execute particular instructions. In distributed computing systems, application programs or modules may be stored in local or remote memory.

The general purpose or personal computer 402 comprises a processor 404, memory 406, device interface 408, and network interface 410, all interconnected through bus 412. The processor 404 represents a single, central processing unit, or a plurality of processing units in a single or two or more computers 402. The memory 406 may be any memory device including any combination of random access memory (RAM) or read only memory (ROM). The memory 406 may include a basic input/output system (BIOS) 406A with routines to transfer data between the various elements of the computer system 400. The memory 406 may also include an operating system (OS) 406B that, after being initially loaded by a boot program, manages all the other programs in the computer 402. These other programs may be, e.g., application programs 406C. The application programs 406C make use of the OS 406B by making requests for services through a defined application program interface (API). In addition, users can interact directly with the OS 406B through a user interface such as a command language or a graphical user interface (GUI) (not shown).

Device interface 408 may be any one of several types of interfaces including a memory bus, peripheral bus, local bus, and like. The device interface 408 may operatively couple any of a variety of devices, e.g., hard disk drive 414, optical disk drive 416, magnetic disk drive 418, or like, to the bus 412. The device interface 408 represents either one interface or various distinct interfaces, each specially constructed to support the particular device that it interfaces to the bus 412. The device interface 408 may additionally interface input or output devices 420 utilized by a user to provide direction to the computer 402 and to receive information from the computer 402. These input or output devices 420 may include keyboards, monitors, mice, pointing devices, speakers, stylus, microphone, joystick, game pad, satellite dish, printer, scanner, camera, video equipment, modem, and like (not shown). The device interface 408 may be a serial interface, parallel port, game port, firewire port, universal serial bus, or like.

The hard disk drive 414, optical disk drive 416, magnetic disk drive 418, or like may include a computer readable medium that provides non-volatile storage of computer readable instructions of one or more application programs or modules 406C and their associated data structures. A person of skill in the art will recognize that the system 400 may use any type of computer readable medium accessible by a computer, such as magnetic cassettes, flash memory cards, digital video disks, cartridges, RAM, ROM, and like.

Network interface 410 operatively couples the computer 302 to one or more remote computers 302R on a local area network 422 or a wide area network 432. The computers 302R may be geographically remote from computer 302. The remote computers 402R may have the structure of computer 402, or may be a server, client, router, switch, or other networked device and typically includes some or all of the elements of computer 402. peer device, or network node. The computer 402 may connect to the local area network 422 through a network interface or adapter included in the interface 410. The computer 402 may connect to the wide area network 432 through a modem or other communications device included in the interface 410. The modem or communications device may establish communications to remote computers 402R through global communications network 424. A person of reasonable skill in the art should recognize that application programs or modules 406C might be stored remotely through such networked connections.

We describe some portions of the recommender using algorithms and symbolic representations of operations on data bits within a memory, e.g., memory 306. A person of skill in the art will understand these algorithms and symbolic representations as most effectively conveying the substance of their work to others of skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For expressively simplicity, we refer to these signals as bits, values, elements, symbols, characters, terms, numbers, or like. The terms are merely convenient labels. A person of skill in the art will recognize that terms such as computing, calculating, determining, displaying, or like refer to the actions and processes of a computer, e.g., computers 402 and 402R. The computers 402 or 402R manipulates and transforms data represented as physical electronic quantities within the computer 402's memory into other data similarly represented as physical electronic quantities within the computer 402's memory. The algorithms and symbolic representations we describe above

The recommender we describe above explicitly incorporates a co-occurrence matrix to define and determine similar items and utilizes the concepts of user communities and item collections, drawn as lists, to inform the recommendation. The recommender more naturally accommodates substitute or complementary items and implicitly incorporates intuition, i.e., two items should be more similar if more paths between them exist in the co-occurrence matrix. The recommender segments users and items and is massively scalable for direct implementation as a Map-Reduce computation.

A person of reasonable skill in the art will recognize that they may make many changes to the details of the above-described embodiments without departing from the underlying principles. The following claims, therefore, define the scope of the present systems and methods.

1. A computer-implemented method, comprising:
programming one or more processors to:
access a list of users stored in one or more user databases and a list of items stored in one or more item databases;
construct user communities of two or more users having an association there between;
construct item collections of two or more items having an association therebetween;
estimate associations between the user communities and the item collections; and
provide one or more recommendations responsive to estimating the associations; and
displaying the one or more recommendations on a display.

2. The computer-implemented method of claim 1 further comprising programming the one or more processors to access the list of users or list of items in one or more memories.

3. The computer-implemented method of claim 1 further comprising programming the one or more processors to construct the user communities by constructing time-varying user communities responsive to a time-varying list of user-user pairs.

4. The computer-implemented method of claim 3 further comprising programming the one or more processors to construct the user communities responsive to time-varying relational probabilities between the user communities and the list of users, the list of items, item collections, or combinations thereof.

5. The computer-implemented method of claim 3 further comprising programming the one or more processors to construct the user communities y₁(τₙ) y₂(τₙ), . . . , yₗ(τₙ) by creating an updated list Eᵤᵥ(τₙ) at a time τ incorporating a time-varying list of user-user pairs Dᵤᵥ(τₙ) into Eᵤᵥ(τₙ) where l and n are integers.

6. The computer-implemented method of claim 5 further comprising programming the one or more processors to construct the user communities y₁(τₙ), y₂(τₙ), . . . , yₗ(τₙ) by:
adding (uᵢ, vⱼ, αeᵢⱼ) to Eᵤᵥ(τₙ) for each triple (uᵢ, vⱼ, eᵢⱼ) in Eᵤᵥ(τₙ₋₁); and
for each pair (uᵢ, vⱼ) in Dᵤᵥ(τₙ), replacing (uᵢ, vⱼ, eᵢⱼ) with (uᵢ, vⱼ, eᵢⱼ+β) if (uᵢ, vⱼ, eᵢⱼ) is in Eᵤᵥ(τₙ), otherwise add (uᵢ, vⱼ, β) to Eᵤᵥ(τₙ);
where β is a predetermined variable; and
where l, n, i, and j are integers.

7. The computer-implemented method of claim 5 further comprising programming the one or more processors to construct the user communities y₁(τₙ), y₂(τₙ), . . . , yₗ(τₙ) by estimating at least one of the probabilities Pr(yₗ|uᵢ; τₙ)⁻ or Pr(vⱼ|yₗ; τₙ)⁻ using the updated list Eᵤᵥ(τₙ) and conditional probabilities Q*(yₗ|uᵢ, vⱼ; τₙ₋₁), where l, n, i, and j are integers.

8. The computer-implemented method of claim 7 further comprising programming the one or more processors to construct the user communities y₁(τₙ), y₂(τₙ), . . . , yₗ(τₙ) by, for each yₗ and each (uᵢ, vⱼ, eᵢⱼ) in Eᵤᵥ(τₙ), estimating Pr(vⱼ|yₗ; τₙ)⁻ as Pr_{N}/Pr_{D}, where Pr_{N} is a sum across uᵢ′ of eᵢⱼQ*(yₗ|uᵢ′, vⱼ; τₙ₋₁) and where Pr_{D} is a sum across yₗ′ and vₗ′ of eᵢⱼQ*(yₗ′|uᵢ, vⱼ′; τₙ₋₁).

9. The computer-implemented method of claim 7 further comprising programming the one or more processors to construct the user communities y₁(τₙ), y₂(τₙ), . . . , yₗ(τₙ) by, for each yₗ and each (uᵢ, vⱼ, eᵢⱼ) in Eᵤᵥ(τₙ), estimating Pr(yₗ|uᵢ; τₙ)⁻ as Pr_{N}/Pr_{D} where Pr_{N} is a sum across vⱼ′ of eᵢⱼQ*(yₗ|uᵢ, vⱼ′; τₙ₋₁) and where Pt_{D} is a sum across yₗ′ and vⱼ′ of eᵢⱼQ*(yₗ′|uᵢ, vⱼ′; τₙ₋₁).

10. The computer-implemented method of claim 7 further comprising programming the one or more processors to construct the user communities y₁(τₙ), y₂(τₙ), . . . , yₗ(τₙ) by estimating conditional probabilities Q*(yₗ|uᵢ, vⱼ; τₙ) for each yₗ and each (uᵢ, vⱼ, eᵢⱼ) in Eᵤᵥ(τₙ).

11. The computer-implemented method of claim 10 further comprising programming the one or more processors to construct the user communities y₁(τₙ), y₂(τₙ), . . . , yₗ(τₙ) by setting Q*(yₗ|uᵢ, vⱼ; τₙ) to Pr(vⱼ|yₗ; τₙ)⁻ Pr(yₗ|uᵢ; τₙ)⁻/Q*_{D} where Q*_{D} is a sum across yₗ′ of Pr(vⱼ|yₗ′;τₙ)⁻Pr(yₗ′|uᵢ; τₙ).

12. The computer-implemented method of claim 10 further comprising programming the one or more processors to construct the user communities yₗ(τₙ), y₂(τₙ), . . . , tₗ(τₙ) by estimating probabilities Pr(yₗ|uᵢ; τₙ)⁺ and Pr(vⱼ|yₗ; τₙ)⁺ for each yₗ and each (uᵢ, vⱼ, eᵢⱼ) in Eᵤᵥ(τₙ).

13. The computer-implemented method of claim 12 further comprising programming the one or more processors to construct the user communities y₁(τₙ), Y₂(τₙ), . . . , yₗ(τₙ) by setting Pr(vⱼ|yₗ; τₙ)⁺ to Pr_{N1}/Pr_{D1} where Pr_{N1} is a sum across uᵢ′ of eᵢⱼQ*(yₗ|uᵢ′, vⱼ; τ) and Pr_{D1} is a sum across uᵢ′ and vⱼ′ of eᵢⱼQ*(yₗ|uᵢ′, vⱼ′; τₙ).

14. The computer-implemented method of claim 13 further comprising programming the one or more processors to construct the user communities y₁(τₙ), y₂(τₙ), . . . , yₗ(τₙ) by setting Pr(yₗ|uᵢ; τₙ)⁺ to Pr_{N2}/Pr_{D2} where Pr_{N2} is a sum across vⱼ′ of eᵢⱼQ*(yₗ|uᵢ, vⱼ′; τₙ) and Pr_{D2} is a sum across yₗ′ and vⱼ′ of eᵢⱼQ*(yₗ′|uᵢ, vⱼ′; τₙ).

15. The computer-implemented method of claim 14 further comprising programming the one or more processors to construct the user communities yₗ(τₙ), y₂(τₙ), . . . , yₗ(τₙ) by:
repeating the estimating conditional probabilities Q*(yₗ,|uᵢ, vⱼ; τₙ) and the estimating probabilities Pr(yₗ|uᵢ; τₙ) and Pr(vⱼ|yₗ; τₙ)⁺ with Pr(vⱼ|yₗ; τₙ)⁻=Pr(vⱼ|yₗ; τₙ)⁺ and Pr(yₗ|uⱼ; τₙ)⁻=Pr(yₗ|uᵢ; τₙ)⁺ if |Pr(vⱼ|yₗ; τₙ)⁻−Pr(vⱼ|yₗ; τₙ)⁺|>d or |Pr(yₗ|uᵢ; τₙ)⁻Pr(yₗ|uᵢ; τₙ)⁺|>d for a predetermined d<<1; and
returning the probabilities Pr(yₗ|uᵢ; τₙ)=Pr(yₗ|uᵢ; τₙ)⁺ and Pr(vⱼ|yₗ; τₙ)=Pr(vⱼ|yₗ; τₙ)⁺, the conditional probabilities Q*(yₗ|uᵢ, vⱼ; τₙ), and the list Eᵤᵥ(τₙ) of triples (uᵢ, vⱼ, eᵢⱼ), where d is a predetermined number.

16. The computer-implemented method of claim 1 further comprising programming the one or more processors to construct the item collections by constructing time-varying items collections responsive to a time-varying list of item-item pairs.

17. The computer-implemented method of claim 16 further comprising programming the one or more processors to construct item collections responsive to time-varying relational probabilities between the item collections and the list of users, the list of items, user communities, or combinations thereof.

18. The computer-implemented method of claim 16 further comprising programming the one or more processors to construct item collections z₁(τₙ), z₂(τₙ), . . . , zₖ(τₙ) by creating an updated list Eₛₜ(τₙ) at a time τ incorporating a time-varying list of item-item pairs Dₛₜ(τₙ) into Eₛₜ(τₙ₋₁), where k and n are integers.

19. The computer-implemented method of claim 16 further comprising programming the one or more processors to construct item collections z₁(τₙ), z₂(τₙ), . . . , zₖ(τₙ) by:
adding (sᵢ, tⱼ, αeᵢₗ) to Eₛₜ(τₙ) for each triple (sᵢ, tⱼ, eᵢⱼ) in Eₛₜ(τₙ₋₁); and
for each pair (sᵢ, tⱼ) in Dₛₜ(τₙ) replacing (vᵢ, tⱼ, eᵢⱼ) with (sᵢ, tⱼ, eᵢⱼ+β) if (sᵢ, tⱼ, eᵢⱼ) is in Eₛₜ(τₙ), otherwise add (sᵢ, tⱼ, β) to Eₛₜ(τₙ);
where β is a predetermined variable; and
where k, n, i, andj are integers.

20. The computer-implemented method of claim 16 further comprising programming the one or more processors to construct item collections z₁(τₙ), z₂(τₙ), . . . , zₖ(τₙ) by estimating at least one of the probabilities Pr(zₖ|sᵢ; τₙ)⁻ or Pr(tⱼ|zₖ; τₙ)⁻ using the updated list Eₛₜ(τₙ) and conditional probabilities Q*(zₖ|sᵢ, tⱼ; τₙ₋₁), where k, n, i, and j are integers.

21. The computer-implemented method of claim 20 further comprising programming the one or more processors to construct item collections z₁(τₙ), z₂(τₙ), . . . , zₖ(τₙ) by, for each Zk and each (sᵢ, tⱼ, eᵢⱼ) in Eₛₜ(τₙ), estimating Pr(tⱼ|zₖ; τₙ)⁻ as Pr_{N}/Pr_{D}, where Pr_{N} is a sum across sᵢ′ of eᵢⱼQ*(zₖ|sᵢ′; τₙ₋₁) and where Pr_{D} is a sum across zₖ′ and tⱼ′ of eᵢⱼ Q*(zₖ′|sᵢ, tⱼ′; τₙ₋₁).

22. The computer-implemented method of claim 20 further comprising programming the one or more processors to construct item collections z₁(τₙ), z₂(τₙ), . . . , zₖ(τₙ) by, for each zₖ and each (sᵢ, tⱼ, eᵢⱼ) in Eₛₜ(τₙ), estimating Pr(zₖ|tᵢ; τₙ)⁻ as Pr_{N}/Pr_{D} where Pr_{N} is a sum across tⱼ′ of eᵢⱼQ*(zₖ|sᵢ, tⱼ′; τₙ₋₁) and where Pr_{D} is a sum across zₖ′ and tⱼ′ of eᵢⱼQ*(zₖ′|sᵢ, tⱼ; τₙ₋₁).

23. The computer-implemented method of claim 20 further comprising programming the one or more processors to construct item collections z₁(τₙ), z₂(τₙ), . . . , zₖ(τₙ) by estimating conditional probabilities Q*(zₖ|sᵢ, tⱼ; τₙ) for each zₖ and each (sᵢ, tⱼ, eᵢⱼ) in Eₛₜ(τₙ).

24. The computer-implemented method of claim 23 further comprising programming the one or more processors to construct item collections z₁(τₙ), z₂(τₙ), . . . , zₖ(τₙ) by setting Q*(zₖ|sᵢ, tⱼ; τₙ) to Pr(tⱼ|zₖ; τₙ)⁻Pr(zₖ|sᵢ; τₙ)⁻/Q*_{D} where Q*_{D} is a sum across zₖ′ of Pr(tₖ|zₖ′; τₙ)⁻Pr(zₖ′sᵢ; τₙ)⁻.

25. The computer-implemented method of claim 23 further comprising programming the one or more processors to construct item collections z₁(τₙ), z₂(τₙ), . . . , zₖ(τₙ) by estimating probabilities Pr(zₖ|sᵢ; τₙ)⁺ and Pr(tⱼ|zₖ; τₙ)⁺ for each zₖ and each (sᵢ, tⱼ, eᵢⱼ) in Eₛₜ(τₙ).

26. The computer-implemented method of claim 25 further comprising programming the one or more processors to construct item collections z₁(τₙ), z₂(τₙ), . . . , zₖ(τₙ) by setting Pr(tⱼ|zₖ; τₙ)⁺ Pr_{N1}/Pr_{D1} where Pr_{N1} is a sum across sᵢ′ of eᵢⱼQ*(zₖ|sᵢ′, tⱼ; τ) and Pr_{D1} is a sum across sᵢ′ and tⱼ′ of eᵢⱼQ*(zₖ|sᵢ′, tⱼ′; τₙ).

27. The computer-implemented method of claim 26 further comprising programming the one or more processors to construct item collections z₁(τₙ), z₂(τₙ), . . . , zₖ(τₙ) by setting Pr(zₖ|sᵢ; τₙ)⁺ to Pr_{N2}/Pr_{D2} where Pr_{N2} is a sum across tⱼ′ of eᵢⱼQ*(zₖ|sᵢ, tⱼ′; τₙ) and Pr_{D2} is a sum across zₖ and tⱼ′ of eᵢⱼQ*(zₖ′|sᵢ, tⱼ′; τₙ).

28. The computer-implemented method of claim 27 further comprising programming the one or more processors to construct item collections z₁(τₙ), z₂(τₙ), . . . , zₖ(τₙ) by:
repeating the estimating conditional probabilities Q*(zₖ|sᵢ, tⱼ; τₙ) and the estimating probabilities Pr(zₖ|sᵢ; τₙ)⁺ and Pr(tⱼ|zₖ; τₙ)⁺ with Pr(tⱼ|zₖ; τₙ⁻=Pr(tⱼ|zₖ; τₙ)⁺ and Pr(zₖ|sᵢ; τₙ)⁻=Pr (zₖ|sᵢ; τₙ)⁺ if |Pr(tⱼ|zₖ; τₙ)⁻−Pr(tⱼ|zₖ; τₙ)⁺|>d or |Pr(zₖ|sᵢ; τₙ)⁻−Pr(zₖ|sᵢ; τₙ)⁺|>d for a predetermined d<<1; and
returning the probabilities Pr(zₖ|sᵢ; τₙ)=Pr(zₖ|sᵢ; τₙ)⁺ and Pr(tⱼ|zₖ; τₙ)=Pr(tⱼ|zₖ; τₙ)⁺, the conditional probabilities Q*(zₖ|sᵢ, tⱼ; τₙ), and the list Eₛₜ(τₙ) of triples (sᵢ, tⱼ, eᵢⱼ), where d is a predetermined number.

29. The computer-implemented method of claim 1 further comprising programming the one or more processors to estimate associations by constructing time-varying association probabilities between at least two item collections.

30. The computer-implemented method of claim 1 further comprising programming the one or more processors to estimate associations by constructing time-varying association probabilities between at least two item collections z₁(τₙ), z₂(τₙ), . . . , zₖ(τₙ) and y₁(τₙ), y₂(τₙ), . . . , yₗ(τₙ) responsive to probabilities Pr(yₖ|uᵢ; τₙ) that uᵢ are members of the item collection yₗ(τₙ), probabilities Pr(tⱼ|zₖ; τₙ) that the item collection zₖ(τₙ) include the tⱼ as members, and a time-varying list D(τₙ) of triples (uᵢ, tⱼ, Sₒ).

31. The computer-implemented method of claim 30 further comprising programming the one or more processors to estimate associations by creating an updated list E(τₙ) at a time τ incorporating a time-varying list of triples D(τₙ) into E(τₙ₋₁), where l and n are integers.

32. The computer-implemented method of claim 31 further comprising programming the one or more processors to estimate associations by:
adding (uᵢ, tⱼ, Sₒ, αeᵢⱼ) to E(τₙ) for each 4-tuple (uᵢ, tⱼ, Sₒ, eᵢⱼₒ) in E(τₙ₋₁); and
for each triple (uᵢ, tⱼ, Sₒ) in D(τₙ), replacing (uᵢ, tⱼ, Sₒ, eᵢⱼₒ) with (uᵢ, tⱼ, eᵢⱼₒ+β) if (uᵢ, tⱼ, Sₒ, eᵢⱼₒ) is in E(τₙ), otherwise add (uᵢ, sⱼ, Sₒ, β) to E(τₙ);
where, β is a predetermined variable; and
where l, n, i, j, o are integers.

33. The computer-implemented method of claim 31 further comprising programming the one or more processors to estimate associations by estimating probabilities Pr(zₖ|yₗ; τₙ)⁻ using the updated list E(τₙ) and conditional probabilities Q*(zₖ, yₗ|uᵢ, t_{jS}ₒ,; τₙ₋₁), where l, n, i, j, and o are integers.

34. The computer-implemented method of claim 33 further comprising programming the one or more processors to estimate associations by, for each yₗ and zₖ, estimating Pr(zₖ|yₗ; τₙ)⁻ as Pr_{N}/Pr_{D}, where Pr_{N} is a sum across uᵢ, tⱼ, and Sₒ of eᵢⱼₒQ*(zₖ, yₗ|uᵢ, tⱼ, Sₒ; τₙ₋₁) and where Pr_{D} is a sum across uᵢ, tⱼ, Sₒ and zₖ′ of eᵢⱼₒQ*(zₖ′, yₗ|uᵢ, tⱼ, Sₒ; τₙ₁).

35. The computer-implemented method of claim 33 further comprising programming the one or more processors to estimate associations by estimating conditional probabilities Q*(zₖ, yₗ|uᵢ, sⱼ, Sₒ; τₙ).

36. The computer-implemented method of claim 35 further comprising programming the one or more processors to estimate associations by, each yₗ and zₖ, estimating probabilities Pr(zₖ|yₗ; τₙ)⁻ as Pr_{N}/Pr_{D}, where Pr_{N} is a sum across uᵢ, tⱼ, and Sₒ of eᵢⱼₒQ*(zₖ, yₗ|uᵢ, tⱼ, Sₒ; τₙ₋₁) and where Pr_{D} is a sum across uᵢ, tⱼ, Sₒ and zₖ′ of eᵢⱼₒQ*(zₖ′, yₗ|uᵢ, tⱼ, Sₒ; τₙ₋₁).

37. The computer-implemented method of claim 35 further comprising programming the one or more processors to estimate associations by estimating the probabilities Pr(zₖ|yₗ; τₙ)⁺.

38. The computer-implemented method of claim 37 further comprising programming the one or more processors to estimate associations by, for each yₗ and zₖ, estimating probabilities Pr(zₖ|yₗ; τₙ)⁺ as Pr_{N}/Pr_{D}, where Pr_{N} is a sum across uᵢ, tⱼ, and Sₒ of eᵢⱼₒQ*(zₖ, yₗ|uᵢ, tⱼ, Sₒ; τₙ) and where Pr_{D} is a sum across uᵢ, tⱼ, Sₒ and zₖ′ of eᵢⱼₒQ*(zₖ′, yₗ|uᵢ, tⱼ, Sₒ; τₙ).

39. The computer-implemented method of claim 37 further comprising programming the one or more processors to estimate associations by, for any pair (zₖ, yₗ), if |Pr(zₖ|yₗ; τₙ)⁻−Pr(zₖ|yₗ; τₙ)⁺|>d for a predetermined d<<1 and the estimating probabilities Pr(zₖ|yₗ; τₙ)⁻ and the estimating probabilities Pr(zₖ|yₗ; τₙ)⁺ have not been repeated more than R times, repeat the estimating probabilities Pr(zₖ|yₗ; τₙ)⁻ and the estimating probabilities Pr(zₖ|yₗ; τₙ)⁺ with Pr(zₖ|yₗ; τₙ)⁻=Pr(zₖ|yₗ; τₙ)⁺, where d is a predetermined variable and R is an integer.

40. The computer-implemented method of claim 38 further comprising programming the one or more processors to estimate associations by, for any pair (zₖ, yₗ) and for |Pr(zₖ|yₗ; τₙ)⁻−Pr(zₖ|yₗ; τₙ)⁺|>d for a predetermined d<<1, let Pr(zₖ|yₗ; τₙ)⁺=[Pr(zₖ|yₗ; τₙ)⁺+Pr(zₖ|yₗ; τₙ)⁺]/2 where d is an predetermined variable.
